(19) United States
(12) Patent Application Publication
(10) Pub. No.: US 2008/0013955 A1
(43) Pub. Date: Jan. 17, 2008

(54) Optical Module and Optical Wavelength Multiplexing and Demultiplexing Device

(75) Inventors: Tetsuo Takano, Tokyo (JP); Kiyoshi Morita, Tokyo (JP); Yoshiatsu Yokoo, Tokyo (JP)

Correspondence Address: OLIFF & BERRIDGE, PLC, P.O. BOX 320850, ALEXANDRIA, VA, 22320-4850, US

(73) Assignee: Hoya Corporation, Tokyo (JP)

(21) Appl. No.: 11/596,052

(22) PCT Filed: May 26, 2004
(86) PCT No.: PCT/JP04/07194

§ 371 Date: Mar. 15, 2007

(51) Int. Cl. H04J 14/02

(52) U.S. Cl. 398/85

(57) ABSTRACT

To provide an optical module with optical elements having a collimator and filter functions arranged on the same substrate, and reducing a complicated alignment and obtaining an excellent optical coupling while securing actually sufficient amount of reflection attenuation. A plurality of wavelength selective filters 71 to 74 with different selective wavelengths are disposed on a substrate 50, so that reflected light reflected by a filter is sequentially made incident, and fiber collimators 101 to 106 combined of an optical fiber terminal with a coreless fiber attached to its tip end and a lens are disposed on an optical path of incident light made incident to a filter on the uppermost stream side, on an optical path of transmitted light transmitted through each filter, and on an optical path of reflected light by a filter on the lowermost stream side. Each fiber collimator is alternately disposed on one side and the other side of one substrate, and positioned so as to be placed in V-grooves 61 to 66 formed on the same plane on the substrate. All of the V-grooves are formed on the same plane, and at least one set of the fiber collimators having a relation of facing to each other through the filter on one side and the other side is disposed on the same axial line.

### TECHNICAL FIELD

The present invention relates to an optical module and optical wavelength multiplexing and demultiplexing device for adding/dropping a signal wave from a trunk line toward a relay station, and inserting the signal light from the relay station into the trunk line, and an optical module used therefore.

### BACKGROUND ART

In an optical communication for which a wavelength division multiplex is used, there is known an optical add/drop multiplexing device, such as being disclosed in the patent document 1, as an device used for the purpose of branching a signal of a particular wavelength to the relay station and inserting the signal of the particular wavelength from the relay station.

As shown in FIG. 17, this optical add/drop device has an optical demultiplexer 3 for demultiplexing a wavelength multiplex light inputted from an input light transmission path 1 into light of each wavelength, and an optical multiplexer 4 for multiplexing the light of each wavelength demultiplexed once and sending it to an output transmission line 2. In addition, a plurality of optical switches 5 are provided in this optical add/drop device, and whether or not the light of each wavelength demultiplexed by the optical demultiplexer 3 is branched to a receiver 7 of a relay station 8 and thereafter the signal transmitted from a transmitter 6 of the relay station 8 is newly inserted, or the light of each wavelength demultiplexed by the optical demultiplexer 3 is transmitted to the optical multiplexer 4 as it is.

In such an add/drop device, a filter module is frequently used in the optical demultiplexer 3 and the optical multiplexer 4 in which a wavelength selective filter and a lens, etc, are fixed on an emitting optical path from optical fiber and which has a function of separating single mode wavelength component from multi-wavelength signals, or a function of inserting the single mode wavelength component into the multi-wavelength signals.

As described in the patent document 2 and the patent document 3, the aforementioned filter module has a structure, so that collimators formed of a lens and optical fiber are disposed in a manner of facing with each other, with a wavelength selective filter sandwiched therebetween.

Generally, in such a filter module, the wavelength selective filter, the lens, and the optical fiber are inserted and fixed in a common cylindrical case, with an optical axis being adjusted. Such a module is generally called an Add/Drop Multiplexer (ADM).

The optical demultiplexer 3 and the optical multiplexer 4 in the optical add/drop device of FIG. 17 need to perform similar multiplexing and demultiplexing for a plurality of wavelengths, and therefore, they are constituted by using a plurality of single mode filter modules having different wavelength separation characteristics and by sequentially splicing optical fibers of a signal incidence/emission end by a method such as fusion. Such a module is generally called “Mux/DeMux”. The light inputted to the optical demultiplexer 3 or the optical multiplexer 4 is demultiplexed into each wavelength or the light of each wavelength is sequentially multiplexed by sequentially passing through a plurality of the aforementioned filter modules (for example, see patent document 4, etc). Note that the aforementioned sequentially connected plurality of single mode modules are generally installed in a single mode case.

Also, separately from this, conventionally known structure is to use a graded index (GI) fiber as the structure of a collimator in which a fiber end face is made perpendicular to an optical axis (for example, see patent document 5).

Patent document 1: Japanese Patent Laid Open No. 2000-183816

Patent document 2: Japanese Publication No. 10-511476

Patent document 3: Japanese Patent Laid Open No. 10-311905

Patent document 4: Japanese Patent Laid Open No. 11-337765

Patent document 5: Japanese Patent Laid Open No. 2003-437270

### DISCLOSURE OF THE INVENTION

### Problem to be Solved by the Invention

Incidentally, in the optical add/drop device using the aforementioned filter module, as the number of channels used in an optical communication becomes larger, the use number of the single mode filter modules need to be increased accordingly. Therefore, a raw material component price is prescribed times or more of the single mode filter module price. In addition, since the step of fusion-splicing of the optical fibers of the incidence/emission end of the filter module is included, there is a problem of high cost due to a complicated step, and also connection loss due to axial deviation during fusion splicing occurs. Further a problem is that useless volume other than a functional part is required, because the single mode filter module is fixed in the case, thereby similarly increasing a component volume required along with an increase of channels.

In order to solve the above-described problems, the inventors of the present invention tries to reduce the price of the optical module, miniaturize, and reduce the connection loss without using a useless component, with a volume reduced to an absolute minimum, by eliminating a housing case, fixing the aforementioned each constituent component on a single substrate, and allowing an optical space transmission.

However, when an element component in the module is actually separated and disposed on the substrate, it is found that the optical axis misalignment occurs in the light emitted from each component, thereby making it impossible to optically couple the optical fiber, and an expected performance can not be obtained.

The following points are considered as factors of the optical axis misalignment.

(1) In order to reduce a reflection loss, end faces of the optical fiber and a distributed refractive index type lens are formed into a slanted-end face;

(2) A deviation occurs between the optical axis of the emitted light and the optical axis of the lens;

(3) The optical axis is misaligned when the light passes through the substrate of a dielectric multilayered film filter as the wavelength selective filter.

Description (1) will be explained in detail. In an optical communication field of recent years, a distribution feedback type laser is generally used as a light source, and a laser light source of this kind has a characteristic that laser oscillation is unstable by a so-called returning light that reversely advances in a fiber to reach the light source, with a result that fluctuation of an output power is easily generated. Namely, in a case of an increase of a reflected light, in other words, when a reflection loss is small, this means a large returning light, resulting in increasing the fluctuation of the output power.

Generally, in order to limit the aforementioned output fluctuation of the laser light source to a level nearly equal to the level that can be ignored, 50 dB or more is required as an end face reflection loss as shown in the following formula (1).
End face reflection loss=−10×log(IR/IO) (1)

Wherein IR indicates a quantity of reflected light, and IO indicates the quantity of incident light.

As a method for obtaining the reflection loss at present, the method of making the fiber end face slant to the optical axis is used. An optical fiber terminal of this type can be obtained by inserting the fiber into a glass capillary and surface-polishing the end face, with the capillary at an angle of about 4° to 8° with respect end face. Thus, the reflected light on the end face is set in a clad mode and attenuates, thus making it possible to obtain a large reflection loss and further large reflection loss of 60 dB or more together with AR coating on the surface. Since this method is significantly simple, it has been a mainstream of a system heretofore.

FIG. 18 shows a collimator manufactured by a manufacturing process of current main stream, namely, the collimator manufactured by combining a fiber pigtail 11 and a distributed refractive index type lens 12. For the reason as described above, an angle of about 8° is formed by each end face of the pigtail 11 and the lens 12, and this causes a positional deviation d and an angle deviation θ to generate in the emitted light with respect to the incident light. Particularly, an optical axis misalignment due to the angle deviation θ becomes larger, as a coupling distance L becomes larger as shown in FIG. 19. Accordingly, collimator pair installed in a V groove, etc, on the same line have almost 0 (zero) optical coupling, when they are spaced apart by several mm or more.

In order to eliminate the aforementioned optical path deviation, all of the optical fiber terminals and the lens end faces are made perpendicular to the optical axis. However, in this case, all end face reflections are reflected as the returning light. The reflection loss generated by a difference in refraction index between the glass end face and air is 14.7 dB, and even if an excellent AR coating (R<0.2% 27 dB) is applied thereon, the reflection loss on the end face is about 42 dB, and this means that the aforementioned required specification of 50 dB or more can not be achieved.

Regarding this point, the patent document 5 provides a structure of an optical fiber end portion having a light condensing function, wherein a beam waist distance and a beam waist diameter can be respectively set at a desired value. Namely, the patent document 5 provides the optical fiber end portion structure capable of changing the beam waist distance and the beam waist diameter mutually independently. However, a problem involved therein is that similarly generally required amount of reflection attenuation can not be secured.

Next, description (2) will be explained. When a normal distributed refractive index type lens is used as a collimator lens, the optical axis is bended for the reason described above. However, instead of this lens, when a spherical surface lens, an aspherical surface lens, and the distributed refractive index type lens that has undergone a spherical surface machining are used, these lenses have deviations in a curvature center of a lens portion with respect to an outside diameter center of the lens, which is generally called decentration, and the fiber optical axis and the lens optical axis do not match, due to a tolerance between the outside diameter of the capillary by which the fiber is coated, and the outside diameter of the lens.

For the reason as described above, when the lens with decentration is used, the following emission angle θ is generated even if the fiber end face and the lens end face are perpendicular to the optical axis.
tan θ=e/f (2)

wherein “e” indicates an amount of decentration, and “f” indicates a focal length.

Similarly, even when the fiber end face and the lens end face are perpendicular to the optical axis, the following emission angle θ is generated when the difference between the outside diameter of the capillary and the outside diameter of the lens is several microns.
tan θ=d/(2·f) (3)

wherein “d” indicates the difference of the outside diameter.

Actually, the decentration and the difference of the outside diameter exist simultaneously, to increase the optical axis misalignment. Therefore, a sufficient optical coupling can not be obtained even if these lenses are disposed in the V-groove.

Next, description (3) will be explained. An interference filter such as a wavelength selective filter is manufactured by forming a film on a glass substrate 15 normally having a finite thickness as shown in FIG. 20, and has a thickness of about 1 mm to escape destruction caused by a generated film pressure. An amount of a parallel positional deviation d (=difference between the optical path to pass when there is no medium 2 and an actual optical path) of the light made incident from a medium 1 having a refractive index of n1 to the medium 2 having a refractive index of n2 and thickness h at an incident angle θ, is shown by the following formula (3).

$$δ = h sin θ [ 1 - \frac{cos θ}{\sqrt{{( \frac{{n}_{2}}{{n}_{1}} )}^{2} - {sin}^{2} θ}} ] \qquad ( Formula 1 )$$

FIG. 21 shows a relation between the amount of the optical axis misalignment d (μm) and the incidence angle θ (Degree) when the light passes through the substrate having various thicknesses (0.5 to 1.5 mm) as shown in FIG. 19. As shown in this figure, the optical axis misalignment is generated depending on the thickness of the substrate and the incidence angle. Therefore, even if a state of the optical coupling of the collimator pair is previously made before inserting the interference filter, the optical path is deviated only by inserting the filter, thus resulting in a significant increase of a loss and a coupling disable state.

As described above, a problem involved therein is that when each component is simply arranged in parallel in each V-groove for fixing components formed on the same substrate, the optical axis misalignment is actually increased, thus making it impossible to obtain the sufficient optical coupling.

In order to solve the above-described problems, the present invention is provided, and an object of the present invention is to provide an optical module and an optical wavelength multiplexing and demultiplexing device using this optical module, realizing miniaturization, having a low insertion loss, with optical elements having a collimator and filter functions arranged on the same substrate, and reducing a complicated alignment and obtaining an excellent optical coupling while securing actually sufficient amount of reflection attenuation.

### Means to Solve the Problem

According to a first invention, an optical module is provided, wherein two sets of first and second fiber collimators are constituted in such a way that one end face of a coreless fiber, which consists of material having a homogeneous refractive index roughly identical to that of the core, is coupled to the end face of an optical fiber having the core of a center portion and a clad disposed on the outer circumference of the core, and a collimator lens is disposed on the other end face side of the coreless fiber on an optical axis of the optical fiber, and the fiber collimators thus constituted are disposed so as to face with each other in a first and second positioning grooves formed on one substrate so as to be positioned on the same axial line, and optical elements having a filter function are arranged between facing surfaces of the fiber collimators.

According to a second invention, the optical module according to the first invention is provided, wherein the fiber collimators are constituted in such a way that a terminal of the optical fiber having the coreless fiber coupled to its end face and the collimator lens are arranged in the positioning grooves.

According to a third invention, the optical module according to the first invention is provided, wherein the fiber collimators are constituted in such a way that the terminal of the optical fiber having the coreless fiber coupled to its end face and the collimator lens are disposed in glass tubes, as a single mode of optical component, and the glass tubes of the fiber collimators constituted as the single mode of optical component are disposed in the positioning grooves.

According to a fourth invention, the optical module according to any one of the first to third inventions is provided, including a wavelength selective filter having a demultiplexing function of allowing only the light of a particular wavelength out of the wavelength multiplex lights made incident to this filter from the first fiber collimator to transmit toward the second fiber collimator and reflect the light of other wavelength, and a multiplexing function of multiplexing toward the first fiber collimator transmitted light of a particular wavelength being made incident to and transmit through one side of this filter from the second fiber collimator, and reflected light of a particular wavelength made incident to and reflect from the other side, and

an optical path correcting board is provided between the wavelength selective filter and the second fiber collimator.

According to a fifth invention, the optical module according to the fourth invention is provided, wherein a third fiber collimator having the same constitution as that of the first and second fiber collimators is disposed in the course of the reflected light made incident from the first fiber collimator and is reflected by the wavelength selective filter, and this third fiber collimator is positioned in a third positioning groove formed on the same plane as the first and second positioning grooves on the substrate.

According to a sixth invention, the optical module according to the fifth invention is provided, wherein the third positioning groove is formed in parallel to the first and second positioning grooves, and an optical path correcting means is disposed between the third fiber collimator disposed in the third positioning groove and the wavelength selective filter, for coupling the reflected light reflected by the wavelength selective filter mutually between the first fiber collimator and the third fiber collimator.

According to a seventh invention, the optical module according to either of the fifth or sixth invention is provided, wherein an optical wavelength demultiplexing device demultiplexes a wavelength multiplex light by using the first fiber collimator as a collimator for input light that allows the wavelength multiplex light sent from an external light transmission path for input to be made incident to the wavelength selective filter as input light, using the second fiber collimator as a collimator for branch light for extracting outside the light of a particular wavelength made incident to and transmitted through the wavelength selective filter, and using the third fiber collimator as a collimator for output light for sending light of the wavelength excluding the particular wavelength made incident to and reflected by the wavelength selective filter to an external light transmission path for output.

According to an eighth invention, the optical module according to the fifth invention or the sixth invention is provided, wherein the light wavelength multiplexing device is constituted by using the third fiber collimator as a collimator for input light for allowing the light of the wavelength excluding a particular wavelength sent from the external input light transmission path to be made incident to the surface of the wavelength selective filter as an input light, using the second fiber collimator as a collimator for insert light for allowing the light of the particular wavelength to be made incident to the backside of the wavelength selective filter as an insert light, and using the first fiber collimator as a collimator for output light for sending the multiplex light of the input light and the insert light to the external light transmission path for output, the input light being reflected by the wavelength selective filter and the insert light transmitting through the wavelength selective filter.

According to a ninth invention, an optical module is provided, including:

a plurality of wavelength selective filters, having a demultiplexing function of allowing only the light of a particular wavelength out of incident lights and reflecting the light of other wavelength, and a multiplexing function of multiplexing transmitted light of a particular wavelength made incident from one side and transmitted through this side and reflected light of other wavelength made incident from other side and reflected by this side, with the particular wavelengths differentiated,

wherein the plurality of selective filters are disposed so that the reflected light reflected by the filter is sequentially made incident from the upstream side to the downstream side in a traveling direction of the light,

collimators are disposed on a light path of incident light made incident to the wavelength selective filter on the uppermost stream side, on a light path of transmitted light that transmits through each wavelength selective filter, and on a light path of the reflected light reflected by the wavelength selective filter on the lowermost stream side, and

as each collimator, one end face of a coreless fiber, which consists of a material having a homogeneous refractive index roughly identical to that of the core, is coupled to an end face of the optical fiber having a center core and a clad disposed on the outer circumference of the core, and by using a fiber collimator wherein a collimator lens is disposed on the other end face of the coreless fiber on the optical axis of the optical fiber,

these fiber collimators are disposed so as to face with each other, alternately on one side and the other side of one sheet of substrate in accordance with multiplexing and demultiplexing order of light, with a disposal space of optical elements including the wavelength selective filter sandwiched between them, and each fiber collimator is positioned by disposing it in a positioning groove formed within the same face of the substrate, and

further at least one set of the fiber collimator having a relation of facing with each other by being disposed on the one side and the other side of the substrate through the wavelength selective filter is disposed in the positioning groove formed on the same axial line, and a light path correcting board is disposed on the light path between both fiber collimators.

According to a tenth invention, the optical module according to the ninth invention is provided, wherein all of the positioning grooves are formed mutually parallel, and an optical path correcting means is interposed at a place where an optical correction occurs by forming the positioning grooves parallel.

According to an eleventh invention, the optical module according to the ninth or tenth invention is provided, wherein a wavelength demultiplexing device for demultiplexing a wavelength multiplex light in multi-stages is constituted, by using the fiber collimator on the uppermost stream side in the traveling direction of the light when used as a demultiplexer as a collimator for input light whereby the wavelength multiplex light sent from the external light transmission path for input is made incident to the wavelength selective filter on the uppermost stream side as an input light, using the fiber collimator on the lowermost stream side as a collimator for output whereby the light reflected by the wavelength selective filter on the lowermost stream side is sent out to the external light transmission path for output, and using the other fiber collimator as a collimator for branch light for extracting outside the light transmitted through each wavelength selective filter.

According to a twelfth invention, the optical module according to either of ninth or tenth invention is provided, which is constituted as an optical wavelength multiplexing device by using the fiber collimator on the uppermost stream side in a traveling direction of light when used as a multiplexer as a collimator for input light whereby the light sent from an external light transmission path for input is made incident to the surface of the wavelength selective filter on the uppermost stream side as an input light, using a fiber collimator on the lowermost stream side as a collimator for output light whereby multiplex light of reflected light and insert light is sent to the external light transmission path for output, the reflected light being reflected by the wavelength selective filter on the lowermost stream side and insert light being transmitted through this filter, and using the other fiber collimator as a collimator for insert light whereby insert light of a particular wavelength for each filter is made incident to the backside of each wavelength selective filter.

According to a thirteenth invention, the optical module according to any one of the first to third inventions is provided, wherein

as an optical element having the filter function, a wavelength selective filter for demultiplexing is provided, whereby only the light of a particular wavelength out of the wavelength multiplex light made incident from the first fiber collimator is allowed to transmit toward the second fiber collimator and reflect the light of other wavelength, and a light path correcting board is provided between the wavelength selective filter and the second fiber collimator; and

the wavelength selective filter for multiplexing is disposed in the course of the reflected light made incident from the first fiber collimator and reflected by the wavelength selective filter for demultiplexing, whereby the light reflected by the wavelength selective filter for demultiplexing is further reflected by its own surface and transmitted light made incident to and transmitted through its own backside is multiplexed with the aforementioned reflected light which is reflected by its own surface,

a third fiber collimator having the same constitution as that of the first and second fiber collimators is disposed in the course of the reflected light made incident from the first fiber collimator and reflected by the wavelength selective filter for demultiplexing and further reflected by the surface of the wavelength selective filter for multiplexing, and

a fourth fiber collimator having the same constitution as that of the first and second fiber collimators is disposed, whereby the light of the wavelength band transmittable through the backside of the wavelength selective filter for multiplexing is made incident to the backside of the wavelength selective filter for multiplexing, and

the third and fourth fiber collimators are respectively disposed in third and fourth positioning grooves formed on the same plane as the first and second positioning grooves on the substrate.

According to a fourteenth invention, the optical module according to the thirteenth invention is provided, wherein the wavelength selective filter for demultiplexing and the wavelength selective filter for multiplexing are formed into wavelength selective filters having the same characteristic of allowing only the light of the same wavelength to transmit therethrough.

According to a fifteenth invention, the optical module according to the thirteenth or fourteenth invention is provided, wherein third and fourth positioning grooves are formed so as to be positioned on the same axial line, and in these third and fourth positioning grooves, the third and fourth fiber collimators are respectively disposed and positioned so as to be faced with each other, with the wavelength selective filter for multiplexing sandwiched between them, and further the light path correcting board is disposed between the fourth fiber collimator and the wavelength selective filter for multiplexing.

According to the sixteenth invention, the optical module according to the fifteenth invention is provided, wherein the first and second positioning grooves and the third and fourth positioning grooves are formed in parallel to each other, the first positioning groove and the fourth positioning groove are disposed on one side of the substrate, the second positioning groove and the third positioning groove are disposed on the other side of the substrate, and the disposal space of the wavelength selective filter is provided between the one side and the other side of the substrate.

According to a seventeenth invention, an optical module is provided, wherein two wavelength selective filters are made to be one set, having a demultiplexing function of allowing only the light of a particular wavelength out of incident light to transmit and reflect the light of other wavelength, and a multiplexing function of multiplexing transmitted light of a particular wavelength made incident from the backside and transmitted through this side and the reflected light of other wavelength made incident from a front surface and reflected by this surface, and a plurality of sets of wavelength selective filters are provided on a substrate, with the particular wavelength differentiated for each set, and the wavelength selective filters are disposed so that the reflected light reflected by the wavelength selective filter is made incident sequentially from the upstream side toward the downstream side in a traveling direction of the light, and so that two wavelength selective filters of each set are continuously disposed, and the wavelength selective filter on the upstream side is used as a filter for multiplexing and the wavelength selective filter on the downstream side is used as a filter for multiplexing, and collimators are respectively disposed:
(a) on a light path of incident light made incident to the wavelength selective filter for demultiplexing on the uppermost stream side,
(b) on a light path of transmitted light transmitted through the wavelength selective filter for demultiplexing of each set on the upstream side,
(c) on a light path of the incident light made incident to the backside of the wavelength selective filter for multiplexing of each set on the downstream side,
(d) on a light path of the reflected light reflected by the wavelength selective filter for multiplexing on the lowermost stream side,
   then, a fiber collimator is used as each collimator,
(e) wherein one end face of a coreless fiber consisting of material having a homogeneous refractive index roughly identical to that of the core is coupled to the end face of the optical fiber which has a core of a center portion and a clad disposed on the outer circumference of the core, and a collimator lens is disposed on the other end face side of the coreless fiber on the optical axis of the optical fiber,
   and out of these fiber collimators, the aforementioned (b) fiber collimator on a light path of transmitted light transmitted through the wavelength selective filter for demultiplexing of each set on the upstream side, the aforementioned (d) fiber collimator on a light path of the reflected light reflected by the wavelength selective filter for multiplexing on the lowermost stream side, the aforementioned (a) fiber collimator on a light path of incident light made incident to the wavelength selective filter for demultiplexing on the uppermost stream side, and the aforementioned (c) on a light path of the incident light made incident to the backside of the wavelength selective filter for multiplexing of each set on the downstream side, are disposed so as to be faced with each other on one side and the other side of one substrate, with disposal space of optical elements including the wavelength selective filter sandwiched between the one side and the other side of the substrate, each fiber collimator is disposed and positioned in a positioning groove formed in the same plane with the substrate, and further at least one set of the fiber collimators having a relation of facing with each other between the one side and the other side of the substrate through the wavelength selective filter are disposed in the positioning groove formed on the same axial line, and an optical path correcting board is disposed on the light path between both fiber collimators.

According to an eighteenth invention, the optical module according to the seventeenth invention is provided, wherein the wavelength selective filter for demultiplexing and the wavelength selective filter for multiplexing of each set are formed into a wavelength selective filter having the same characteristics of allowing only the light of the same wavelength to transmit therethrough.

According to a nineteenth invention, the optical module according to the seventeenth or eighteenth invention is provided, wherein all of the positioning grooves are formed in parallel to each other, and an optical path correcting means is interposed at a place where a correction of an optical path is generated by forming the poisoning grooves in parallel.

According to a twentieth invention, the optical module according to any one of the sixth, tenth, and nineteenth invention is provided, wherein as the optical path correcting means, at least any one of mirror, mirror having a ginbal mechanism, a totally reflective prism, and a refractive prism is used.

According to a twenty-first invention, the optical module according to any one of the first to twentieth inventions is provided, wherein as the positioning groove, any one of a V-groove, a round groove, a rectangular groove, and an oval groove is provided.

According to a twenty-second invention, the optical module according to any one of the first to third inventions is provided, wherein when intensity of incident light is not uniform over a wavelength, a gain equalizing filter for correcting a light intensity is used so as to flatten the intensity, as the optical element having the filter function.

According to a twenty-third invention, the optical module according to any one of the first to third inventions is provided, wherein a filter for extracting only a part of a quantity of incident light is used as the optical element having the filter function.

According to the twenty-fourth invention, an optical wavelength multiplexing and demultiplexing device is provided, wherein an optical module constituted as the optical wavelength demultiplexing device of the seventh invention and an optical module constituted as the optical wavelength multiplexing device of the eighth invention are paired and combined.

According to a twenty-fifth invention, an optical wavelength multiplexing and demultiplexing device is provided, wherein an optical module constituted as the optical wavelength demultiplexing device of the eleventh invention and an optical module constituted as the optical wavelength multiplexing device of the twelfth invention are paired and combined.

### ADVANTAGES OF THE INVENTION

According to the first invention, the fiber collimator is constituted by combining the optical fiber terminal and the collimator lens adapted to lessen an optical axis deviation by arranging the coreless fiber on the tip and realize a sufficient reflection attenuation amount, and the fiber collimator thus constituted is disposed on the positioning groove formed on one substrate so as to be positioned on the same axial line. Therefore, a high efficient optical coupling can be easily obtained between fiber collimators. In addition, the optical elements having a filter function are arranged on the optical path. Therefore, output light obtained by applying a desired filtering to input light can be obtained with a low loss. Also, each constituent component is disposed and fixed on a common substrate, and the light is allowed to perform space transmission between components. Therefore, without using a useless component, and with a minimum necessary volume, the optical module can be miniaturized at a low cost.

According to the second invention, the optical fiber terminal and the lens are positioned in the positioning groove on the substrate. Therefore, the number of components is lessened, thereby realizing a low cost.

According to the third invention, the fiber collimator is constituted by previously disposing the optical fiber terminal and the collimator lens in the glass tube, which is then disposed in the positioning groove on the substrate. Therefore, easy assembling is realized.

According to the fourth invention, the wavelength selective filter is used as the optical element having filter function. Therefore, only the light of a particular wavelength out of the input light can be extracted from the fiber collimator on the output side.

According to the fifth invention, the third fiber collimator aligned on the same plane with the first and second fiber collimators is disposed in the course of the light reflected by the wavelength selective filter. Therefore, the high efficient optical coupling can be easily obtained among first to third fiber collimators. In addition, by setting the first and third fiber collimators as an input/output port, and by setting the second fiber collimator as a branch/insertion port, the optical demultiplexer or the optical multiplexer of 1-channel type with low loss can be easily obtained. Particularly, in this case, a single module is used for exclusively for optical demultiplexing or optical multiplexing, and therefore there is no problem that insert light inserted toward the wavelength selective filter for multiplexing is reflected and mixed by demultiplexed branching light, even if by a small amount.

According to the sixth invention, the first to third positioning grooves are formed in parallel, and each fiber collimator is disposed in each positioning groove, and a necessary optical path adjustment may be performed by the optical path correcting means (such as mirror and a prism). This contributes to easy processing/assembling.

According to the seventh invention, the optical module of the present invention can be easily used as 1-channel type optical demultiplexer when the optical wavelength demultiplexing device is constituted.

According to the eighth invention, the optical module of the present invention can be easily used as 1-channel type optical multiplexer when the optical wavelength demultiplexing device is constituted.

According to the ninth invention, the optical module of the present invention can be easily used as a multi-channel type optical demultiplexer or optical multiplexer. In addition, plural-wavelengths multiplexer/demultiplexer manufactured by connecting a plurality of usually 1-channel type multiplexer/demultiplexers is constituted so that each constituent component such as collimator and wavelength selective filter is integrated and deployed on the same substrate, and optical space transmission between components is allowed. Therefore, a small-sized optical wavelength multiplexer/demultiplexer with low loss can be easily obtained without using a useless component, with a minimum necessary volume. In addition, the fiber collimator is used, which is formed by combining the optical fiber terminal and the collimator lens and whereby the optical axis deviation is lessened and a sufficient reflection attenuation is realized by arranging the coreless fiber on the tip part. Therefore, assembling is facilitated, the high efficient optical coupling can be obtained between each fiber collimator, and the multi-channel type optical module suitable for obtaining the optical multiplexer/demultiplexer with low loss can be provided. Particularly, in this case, the single mode of module is used exclusively for either of the optical demultiplexing or optical multiplexing. Therefore, there is no problem arises, such that the insert light that inserts toward the wavelength selective filter for multiplexing is reflected by demultiplexed branching light and mixed therein, even if by a small amount.

According to the tenth invention, all of the positioning grooves are formed in parallel, the fiber collimator is disposed in each positioning groove, and a necessary adjustment of the optical path may be performed by an optical path correcting means (such as mirror and prism). Therefore, the processing/assembling is facilitated.

According to the eleventh invention, the optical module can be easily used as the multi-channel type optical demultiplexer when the optical wavelength demultiplexing device is constituted.

According to the twelfth invention, the optical module can be easily used as the multi-channel type optical multiplexer when the optical wavelength multiplexing device is constituted.

According to the thirteenth invention, by defining the first fiber collimator as an input port, defining the third fiber collimator as an output port, defining the second fiber collimator as a branch port, and defining the fourth fiber collimator as a insert port, the optical module can be used as the optical wavelength multiplexer/demultiplexer with low loss. In addition, each constituent component is fixed on the common substrate, and the optical space transmission between components is allowed. Therefore, the optical module can be miniaturized at a low cost, without using a useless component and with a minimum necessary volume. Further, in this invention, two sheets of wavelength selective filters for optical demultiplexing and optical multiplexing are provided on the single mode of module. Therefore, there is no problem that the insert light that inserts toward the wavelength selective filter for multiplexing is mixed in demultiplexed branching light.

According to the fourteenth invention, two sheets of wavelength selective filters for optical demultiplexing and optical multiplexing having the same characteristics are provided in the single mode modules. Therefore, by defining the first fiber collimator as the input port, defining the third fiber collimator as the output port, defining the second fiber collimator as the branch port, and defining the fourth fiber collimator as the insert port, the optical module can be used as the 1-channel type optical wavelength multiplexer/demultiplexer with a low loss.

According to the fifteenth invention, the first and second, and the third and fourth positioning grooves are respectively formed on the same straight line. Therefore, the processing/assembling can be facilitated.

According to the sixteenth invention, the first and second, and the third and fourth positioning grooves are further formed in parallel. Therefore, the processing can be further facilitated and a precision can be improved.

According to the seventeenth invention, by defining the fiber collimator on the uppermost stream side as the input port, defining the fiber collimator on the lowermost stream side as the output port, and defining the other fiber collimator as the branch or insert port, the optical module can be used as the multi-channel type optical wavelength multiplexer/demultiplexer. In addition, each constituent component is fixed on the common substrate, and the optical space transmission between components is allowed. Therefore, the optical module can be miniaturized at a low cost, without using a useless component, with a minimum necessary volume. Further, in this invention, two wavelength selective filters for optical demultiplexing and optical multiplexing are combined and set in the single mode modules. Therefore, there is no problem that the insert light that inserts toward the wavelength selective filter for multiplexing is mixed in the demultiplexed branching light.

According to the eighteenth invention, two sheets of wavelength selective filters for optical demultiplexing and optical multiplexing for each particular wavelength are provided in the single mode modules. Therefore, there is no problem that the insert light that inserts toward the wavelength selective filter for multiplexing is mixed in the demultiplexed branching light.

According to the nineteenth invention, all of the positioning grooves are formed in parallel, and the fiber collimator may be disposed in each positioning groove. Therefore, the processing/assembling is facilitated.

In addition, according to the twentieth invention, at least any one of the mirror, the mirror having the ginbal mechanism, the totally reflective prism, and the refractive prism can be used. According to the twenty-first invention, the round groove, the rectangular groove, and the oval groove, etc, can be used other than the usually used V-groove, as the positioning groove. According to the twenty-second and twenty-third invention, when the intensity of incident light is not uniform over the wavelength, the gain equalizing filter that corrects the light intensity so as to flatten the strength, or the filter for extracting only a part of the amount of the incident light can be used instead of the wavelength selective filter, as the optical element having the filter function.

Further, according to the twenty-fourth invention, the optical module of the seventh invention and the optical module of the eighth invention are combined to constitute the 1-channel type optical wavelength multiplexing and demultiplexing device, and according to the twenty-fifth invention, the optical module of the eleventh invention and the optical module of the twelfth invention are combined to constitute the multi-channel type optical wavelength multiplexing and demultiplexing device.

### BEST MODE FOR CARRYING OUT THE INVENTION

Hereafter, embodiments of the present invention will be explained based on the drawings.

First, an optical module A of a first embodiment, which is the most basic structure, will be explained with reference to FIG. 1.

### Optical Module A (First Embodiment)

In the optical module A as shown in FIG. 1, two sets of the first and second fiber collimators 101 and 102 are disposed so as to face with each other, in first and second positioning grooves 61 and 62 formed to be positioned on the same axial line on one substrate 50, and an optical element 70 having a filter function and an optical path correcting board 80 are disposed between faced surfaces of the fiber collimators 101 and 102, and optical space transmission between respective components is performed.

An optical element disposal face (optical element disposal space) 51, whose upper surface is recessed by one step from right and left sides, is secured in the center of the substrate 50, and collimator disposal faces 52 and 53, which are remained slightly higher than the optical element disposal face 51 are secured on the both sides. The collimator disposal faces 52 and 53 on both sides are within the same surface, and both of the optical element disposal face 51 and the collimator disposal faces 52 and 53 are formed into flat parallel planes. Then, V-grooves are processed through each collimator disposal face 52, 53, as poisoning grooves 61 and 62.

Note that in each embodiment as will be described hereunder, the optical element disposal face 51 of the center and the collimator disposal faces 52 and 53 on both sides thereof have functionally the same relation, although they are different in dimension. Accordingly, an explanation is not individually given in particular.

This optical module A is a module having a function to apply filtering to input light inputted through the first fiber collimator 101 from an optical fiber 1001 for external input, by the optical element 70 having a filter function, and output it to an optical fiber 1002 for external output through the second fiber collimator 102, and specifically constituted as will be described hereunder.

First, the substrate 50 is composed of a glass substrate, and the two positioning grooves 61 and 62 are formed so as to be positioned on the same axial line on the right and left collimator disposal faces 52 and 53. In this case, since the two positioning grooves 61 and 62 are positioned on the same straight line, by cutting. Accordingly, high mutual positional accuracy can be easily secured.

Note that sectional shapes of the positioning grooves 61 and 62, which are given as examples here, are mainly V-shape (V-groove). Therefore, they are sometimes called “V-grooves” instead of “positioning grooves”. A half-round type, U-type, and rectangular type are given as the other examples of the positioning grooves 61 and 62. In addition, the substrate 50 may be composed of silicon, ceramic, metal, and resin, etc, other than glass. The same thing can be said for each embodiment and therefore an explanation therefore is omitted.

FIG. 2 and FIG. 3 show constitutional examples of each fiber collimator 101, 102.

An optical fiber terminal 110 constituting the fiber collimators 101 and 102 is constituted in such a manner that one end face of a coreless fiber (CLF) 112 which consists of material having a homogeneous refractive index roughly identical to that of the core 111a is fused and bonded to an end face of a single mode optical fiber (SMF) 111 with a standard outer diameter of 125 μm and arbitrary length, having a core 111a of a center part and a clad 111b of its outer circumference. Then, the other end face of the coreless fiber 112 is ground and/or polished into 0° with respect to a surface vertical to the optical axis of the optical fiber 111, and further this is passed through a single-core ferrule having 1.249 mm of outer diameter generally used for mounting the optical module, to be bonded and fixed thereto, and an antireflection film is formed thereon. However, dimensions of these optical fiber 111 and ferrule 115 are not limited to the aforementioned dimensions.

Then, by disposing a collimator lens 120 on the other end face side of the coreless fiber 112 on an optical axis of the optical fiber terminal 110, each fiber collimator 101, 102 is constituted.

The collimator lens 120 is a lens designed to function to change diffused lights emitted from the optical fiber terminal 110 into parallel lights, when used on the light-emitting side (when disposed immediately after the optical fiber terminal), and when used on the light-receiving side (light input side) (when disposed immediately in front of the optical fiber terminal), and function to couple space-transmitted light to the optical fiber terminal 110. The collimator lens 120 in this case is formed of a so-called drum-type lens obtained by cutting the outer circumference of a ball lens into a cylindrical shape, and is designed so that an external shape difference from the ferrule 115 is 2 μm or less, lens eccentricity is 1 μm or less, a focal distance is 2.6 mm, and the outer diameter is 1.249 mm, so as to prevent a generation of an optical axis deviation with respect to the optical fiber terminal 110.

However, not only the drum-type lens, but other lenses can be used as the collimator lens 120, such as a spherical lens, an aspherical lens, a ball lens, a distributed refractive index type lens whose end face on the light-emitting side is subjected to curved face machining, and the lens, whose one face from which at least the parallel lights are emitted or into which at least the parallel lights are introduced, is not a flat surface vertical to the optical axis.

The wavelength selective filter (shown by the same designation mark “70” hereafter) is used here as an optical element 70 having the filter function. The wavelength selective filter 70 has a demultiplexing function to allow only the light of a particular wavelength to transmit out of the incident lights and reflect the light of other wavelength, and a multiplexing function to multiplex the light of a particular wavelength made incident to and transmitted through this filter from one face and the light of other wavelength made incident to and reflected by this filter from the other face.

By the wavelength selective filter 70, an optical multi-layer film (example: dielectric multi-layer film) is formed on a light-transmissive substrate such as glass and resin, to make it possible to exert filter characteristics by a material and a layer structure of the optical multi-layer film. The optical multi-layer generally has a structure of alternately laminating the material with a small refractive index and the material with a large refractive index. Dimension is set as 1.4×1.4×1.2 mm, for example.

The optical path correcting board 80 is a parallel flat plate glass substrate, with both faces applied with antireflection film, and has roughly the same material and dimension as those of the substrate of the wavelength selective filter 70.

When a parallel flat plate wavelength selective filter 70 is obliquely inserted between the optical paths of the facing fiber collimators 101 and 102, the light depends on a thickness of the glass substrate, thus generating a positional deviation in parallel to an original optical axis. Such a deviation can be restored to the original optical axis by using a similar glass substrate, thus making it possible to easily maintain a low loss coupling. Therefore, the optical path correcting board 80 is provided so as to be paired with the wavelength selective filter 70.

<Manufacturing Procedure of Optical Module A>

The optical module A can be manufactured as will be described hereunder. Explanation will be given by using FIG. 1 and FIG. 2.

Here, the explanation is given to a case of separately disposing the optical fiber terminal 110 and the collimator lens 120 in the V-grooves 61 and 62, to manufacture the fiber collimators 1010 and 102.

In this case, first, the substrate 50 formed with V-grooves (positioning grooves) 61 and 62 is prepared. Then, the optical fiber terminal 110 and the collimator lens 120 are disposed and adjusted in the first V-groove 61 of the substrate 50, and the first fiber collimator 101, which is one of the fiber collimators, is firstly prepared.

In its procedure, first, either one of the optical fiber terminal 110 or the collimator lens 120 disposed in the first V-groove 61 is firstly fixed to the V-groove 61. Next, a distance between them is set so as to obtain a previously set collimation state, and thereafter, the other one (which is not firstly fixed) is fixed.

The setting of this positional relation adopts a method of introducing the light to the optical fiber terminal 110, to couple and adjust collimated light that passes through the collimator lens 120, by a previously manufactured collimator. At this time, an adjusting member (the optical fiber terminal 110 or the collimator lens 120 subsequently fixed) has only to be positioned in 1-axial direction along the V-groove 61, thus facilitating the adjustment. Note that such a distance setting can also be performed by using a method of adjusting the collimated light by placing a detector far off, a method of recognizing the distance between the optical fiber terminal 110 and the collimator lens 120 by an image, and a method of monitoring and adjusting the light reflected by mirror placed at a specified distance from the lens by using a circulator.

Next, in the same way, the optical fiber terminal 110 and the collimator 120 are disposed and adjusted in the second V-groove 62 which is another one of the facing grooves, and the second fiber collimator 102 is manufactured. In this case also, either one of the optical fiber terminal 110 or collimator lens 120 is firstly fixed in the V-groove 62, and the distance between them is adjusted while confirming the collimation state, and thereafter, another one is subsequently fixed and the second fiber collimator 102 is manufactured.

When adjusting the distance, a firstly manufactured first fiber collimator 101 can be used. Namely, the light is inputted through the first fiber collimator 101, and parallel beams emitted from the first fiber collimator 101 are coupled to the optical fiber terminal 110 through the collimator lens 120 in the second V-groove 62. Then, by measuring a light amount received by the optical fiber terminal 110 through the collimator lens 120, the distance between the optical fiber terminal 110 and the collimator lens 120 in the second V-groove 62 is adjusted and fixed, while confirming the collimation state. In this case also, the optical fiber terminal 110 or the collimator lens 120 has only to be 1-axially positioned along the V-groove 62, thus facilitating the adjustment.

Next, the wavelength selective filter 70 is disposed so as to be positioned on the light paths of the first fiber collimator 101 and the second fiber collimator 102, and the light path correcting board 80 is disposed between the wavelength selective filter 70 and the second fiber collimator 102, and the optical module A is thereby completed.

In this way, the fiber collimators 101 and 102 are constituted by combining the optical fiber terminal 110 and the collimator lens, which is adapted to lessen an optical axis deviation by arranging the coreless fiber 112 on the tip to realize a sufficient reflection attenuation amount. Then, the fiber collimators 101 and 102 thus constituted are disposed in V-grooves (positioning grooves) formed on one substrate 50 so as to be positioned on the same axial line. Therefore, a high efficient optical coupling can be easily obtained between fiber collimators 101 and 102.

In addition, the optical elements 70 having a filter function are arranged on the optical path between both of the fiber collimators 101 and 102. Therefore, output light obtained by applying a desired filtering to input light can be obtained with a low loss. Also, each constituent component is disposed and fixed on the common substrate 50, and the light is allowed to perform space transmission between components. Therefore, without using a useless component, and with a minimum necessary volume, the optical module A can be miniaturized at a low cost.

In addition, in the aforementioned example, the fiber collimators 101 and 102 are constituted by directly disposing the optical fiber terminal 110 and the collimator lens 120 in the V-grooves 61 and 62. However, as shown in FIG. 3, it may be so constructed that the fiber collimators 101 and 102 are previously constituted as a single optical component by disposing the optical fiber terminal 110 and the collimator lens 120 in a glass tube 116, and the glass tube 116 of the fiber collimators 101 and 102 are disposed in the V-grooves 61 and 62.

The former has a merit of reducing a cost with a less number of components, and the latter has a merit of facilitating an assembly.

Also, in the aforementioned example, the case of using the wavelength selective filter is shown as the optical element 70 having the filter function. However, it can be replaced with another filter, for example, the gain equalizing filter for correcting the light intensity so as to be flattened when the intensity of the introduced light is not uniform with respect to the wavelength, and a filter for extracting only a part of an amount of light of the introduced light.

<Regarding Series B and Series C>

Next, the explanation will be given to a series B and a series C of the optical module, on the assumption that they are used as the optical wavelength demultiplexing device or a usage as the optical wavelength demultiplexing device. The series B is a type of forming all of the V-grooves in parallel to each other on the same plan on the substrate 50, and the series C is a type of forming some of the V-grooves in parallel to each other, and forming the remaining V-grooves into angles not parallel to each other.

As is seen in the series B, when the V-grooves are formed in parallel to each other on the substrate 50, there is an advantage that precision adjustment for groove machining is facilitated. However, there is definitely a possibility that an advance direction of light needs to be bent, thus requiring a light path correcting means to be provided (mirror or prism). Meanwhile, when the V-groove machining is performed irrespective of parallelism, a lot of labor is spent in adjusting precision for performing groove machining. However, an advantage is that necessity of optical path correction in the subsequent step is eliminated.

<Regarding Optical Module of Series B>

First, the series B will be explained.

In the series B, the V-grooves are all formed in parallel to each other in the same plane on the substrate 50, and single mode optical modules B (B1, B2, B3) are created on the assumption that they are exclusively used for either one of the optical wavelength multiplexing device or the optical wavelength demultiplexing device.

Here, as the type of the series B, an explanation will be given sequentially to each case of an optical module B1 for 1 channel (ch), an optical module B2 for 2 channel (ch), and an optical module B3 for 4 channel (ch). These optical modules are given as a second embodiment, a third embodiment, and a fourth embodiment of the present invention.

### Optical Module B1 (Second Embodiment)

First, by using FIG. 4 and FIG. 5, a most basic optical module B1 for 1ch will be explained.

This optical module B1 is so constituted that two sets of first and second fiber collimators 101 and 102 are disposed so as to face with each other in the first and second positioning grooves (V-grooves) 61 and 62, which are formed to be positioned on the same axial line on one substrate 50; the wavelength selective filter 70 and the optical path correcting board 80 are disposed between opposite facing faces of the fiber collimators 101 and 102; a third fiber collimator 103 having the same constitution as that of the first and second fiber collimators 101 and 102 is further disposed on the course of the reflected light made incident from the first fiber collimator 101 and reflected by the wavelength selective filter 70; and the third fiber collimator 103 is positioned and disposed in the third positioning groove (V-groove) 63 formed in the same plan as the first and second positioning grooves 61 and 62 on the substrate 50, to allow the space transmission of light to be performed between each component.

The third V-groove 63 is formed in parallel to the first and second V-grooves 61 and 62, and a mirror 90 is disposed as the optical path correcting means between the third fiber collimator 103 and the wavelength selective filter 70 disposed in the third V-groove 63, so that the reflected light reflected by the wavelength selective filter 70 is coupled to each other between the first fiber collimator 101 and the third fiber collimator 103.

Here, each of the fiber collimators 101 to 103, the substrate 50, the wavelength selective filter 70, and the optical path correcting board 80 have the same constitutions respectively as those shown in FIG. 1 mainly except for a dimensional difference of substrate 50. Therefore the explanation therefore is omitted.

The mirror 90 as the optical path correcting means used in this embodiment functions to change the optical path and correct deviation of an optical axis generated by outline accuracy of the component and the deviation of the optical axis when the component passes. Accordingly, it is desirable to use the mirror having a Gimbal mechanism or the mirror having an adjustment mechanism based on this mirror. The mirror having the Gimbal mechanism refers to the mirror whose inclination can be adjusted, with one point (normally center) of the mirror set as a rotation center.

It is suitable that metallic mirror such as aluminum and gold is used as the mirror 90, from the point that the metallic mirror has good reflectivity and durability. Here, the mirror obtained by adding a film of aluminum and magnesium fluoride to a glass board having a size of 2×5×1 mm is used. In addition, as the optical path correcting means, not only the reflective mirror, but also a wedge prism can be used. In a case of the wedge prism, the optical path can be bent by refraction or total reflection, and correction of the optical path can be performed.

<Manufacturing Procedure of the Optical Module B1>

The optical module B1 can be manufactured as follows.

First, the substrate 50 is prepared, wherein the first and second V-grooves 61 and 62 are formed on the same axial line, and the third V-groove 63 is further formed in parallel to the first V-groove 61. However, the third V-groove 63 is formed on the same side as the first V-groove 61. Next, in the same way as the case of the optical module A, the fiber terminal 110 and the collimator lens 120 are respectively disposed in the first and second V-grooves 61 and 62 to adjust the position, and the first and second fiber collimators 101 and 102 are manufactured.

Next, the wavelength selective filter 70 is disposed on the light path between the first fiber collimator 101 and the second fiber collimator 102 at a previously designed angle, and the optical path correcting board 80 is disposed between the wavelength selective filter 70 and the second fiber collimator 102 at an angle symmetrical with the wavelength selective filter 70.

Next, the optical fiber terminal 110 and the collimator lens 120 are disposed and the third fiber collimator 103 is assembled temporarily, in the third V-groove 63. Then, the mirror 90 as the optical path correcting means is disposed in front of the third fiber collimator 103, and in this state, the light of the wavelength that is reflected by the wavelength selective filter 70 is made incident to the first fiber collimator 101, and while confirming a quantity of light reflected by the wavelength selective filter 70 and coupled to the third fiber collimator 103 through the mirror 90, the position and direction of the mirror 90 and a distance between the optical fiber terminal 110 and the collimator lens 120 constituting the third fiber collimator 103 are determined and fixed. Thus, the optical module B1 can be obtained.

In this optical module B1, the third fiber collimator 103, which is aligned with the first and second fiber collimators 101 and 102 on the same plan, are disposed on the course of the reflected light reflected by the wavelength selective filter 70. Therefore, a high efficient optical coupling can be easily obtained among the first to third fiber collimators 101 to 103. Also, by setting the first and third fiber collimators 101 and 103 as an input-output port, and by setting the second fiber collimator 102 as a branch insertion port, the optical demultiplexer or the optical multiplexer of 1 channel type with low loss can be easily constituted.

Particularly, in this case, the single mode module B1 is used exclusive for either one of the optical demultiplexing or the optical multiplexing. Therefore, no problem is involved therein, such that the insert light inserted toward the wavelength selective filter 70 for multiplexing is reflected and mixed in a demultiplexed branching light even by a small amount.

Next, by using FIG. 5, the explanation will be given to the case of using the optical module B1 as the optical wavelength multiplexing device or the optical wavelength multiplexing device for 1ch.

<Case of Using the Optical Module B1 as the Optical Wavelength Multiplexing Device>

When the optical module B1 is used as the optical wavelength multiplexing device, as shown in FIG. 5(a), the optical fiber terminal 110 of the first fiber collimator 101 is used as a terminal for input (In) whereby wavelength multiplexed light (light including λ1) sent from an external light transmission path 1001 for input is made incident to the wavelength selective filter 70 as input light, and the optical fiber terminal 110 of the second fiber collimator 102 is used as a terminal for demultiplexing (Drop) for extracting the transmitted light of a particular wavelength λ1, which is made incident to and transmitted through the wavelength selective filter 70, to an external light transmission path 1002 for demultiplexing, and the optical fiber terminal 110 of the third fiber collimator 103 is used as a terminal for output for sending the light other than the light of the particular wavelength λ1, which is made incident to and reflected by the wavelength selective filter 70, to an external light transmission path 1003 for output. In this way, the function of demultiplexing the wavelength multiplexed light (function of extracting the light of particular wavelength λ1) is exhibited.

<When the Optical Module B1 is Used as the Optical Wavelength Multiplexing Device>

Meanwhile, when the optical module B1 is used as the optical wavelength multiplexing device, as shown in FIG. 5(b), the optical fiber terminal 110 of the third fiber collimator 103 is used as the terminal for input (In) whereby the light other than the light of the particular wavelength λ1, which is sent from the external light transmission path 1003 for input, is made incident to the surface of the wavelength selective filter 70 as input light; the optical fiber terminal 110 of the second fiber collimator 102 is used as a terminal for insertion (Add) whereby the insert light of the particular wavelength λ1, which is sent from the external light transmission path 1002 for insertion, is made incident to the backside of the wavelength selective filter 70 as insert light; and multiplex light of input light reflected by the wavelength selective filter 70 and the insert light that transmits through this filter is used as a terminal for output (Out) whereby the multiplex light is sent to the light transmission path 1001 for output. Thus, the function of multiplexing the lights of different wavelengths (here, function of inserting and multiplexing the lights of the particular wavelength λ1) is exhibited.

As described above, the optical module B1 of this embodiment can be used as a single mode component and an exclusive tool for either one of the optical demultiplexing device or the optical multiplexing device.

### Optical Module B2 (Third Embodiment), Optical Module B3 (Fourth Embodiment)

Next, by using FIG. 6 to FIG. 9, optical modules B2 and B3 for 2ch or more (for 2ch and for 4ch) will be explained.

FIG. 6 and FIG. 7 show the optical module B2 for 2ch, and FIG. 8 and FIG. 9 show the optical module B3 for 4ch. The optical modules B2 and B3 for 2ch or more are basically constituted as described below. Note that a basic constitution of the optical module B2 for 2ch is included in the optical module B3 for 4ch, and therefore here, the optical module B3 for 4ch will be previously explained.

First, the optical module B3 is equipped with four wavelength selective filters 71 to 74 having a demultiplex function of allowing only the light of the particular wavelength to transmit out of the incident lights and the light of other wavelength to reflect, and a multiplexing function of multiplexing the transmitted light of a particular wavelength made incident to and transmitted through from one side, and the reflected light of other wavelength made incident to and reflected from the other side, with the particular wavelength differentiated, and these four wavelength selective filters 71 to 74 are sequentially arranged from the upstream side to the downstream side in a traveling direction of the light, so that the reflected lights reflected by the wavelength selective filters 71 to 74 can be made incident thereto.

The traveling direction of the light for multiplexing is explained here, collimators are disposed on the light path of the light made incident to the wavelength selective filter 71 on the uppermost stream side; on the light path of the light that transmits through each wavelength selective filters 71 to 74; and on the light path of the light reflected by the wavelength selective filter 74 on the lowermost stream side.

Fiber collimators 101 to 106 which are completely the same collimators as those explained in FIG. 1 to FIG. 4 are used as each collimator. These fiber collimators 101 to 106 are arranged alternately on one side and the other side of one sheet of common substrate 50, so as to face with each other, with a disposal space (optical element disposal face 51) of the optical elements including the wavelength selective filters 71 to 74 interposed the one side and the other side of the sheet.

Then, each of the fiber collimators 101 to 106 are respectively disposed and positioned in the V-grooves 61 to 66 formed in the same plan on the collimator disposal faces 52 and 53 of the substrate 50, and further some sets of the fiber collimators having facing relations through the wavelength selective filters 71 to 74 on one side and the other side of the substrate 50 (in this example, the first and second fiber collimators 101 and 102, 103 and 106) are disposed in the V-grooves 61 and 62, and in the V-grooves 63 and 66 formed on the same axial line. In this case, all V-grooves 61 to 66 are formed in parallel to each other. Also, at a place where an optical path correction is needed, by forming the V-grooves 61 to 66 in parallel to each other, mirrors 91 and 92 for optical path correction are disposed. In addition, at a place where the optical path correction directed to each fiber collimator 101 to 106 is needed by disposing the wavelength selective filters 71 to 74, namely, in a case shown by an example of this figure, on the light path where the wavelength selective filters 71 and 73 are disposed, optical path correcting boards 81 and 82 are disposed at an angle symmetrical with the wavelength selective filters 71 and 73.

Note that each fiber collimator 101 to 106, the substrate 50, the wavelength selective filter 70, and the optical path correcting board 80 have the same structures as those as shown in FIG. 1, except for mainly the dimensional difference of the substrate 50, and therefore the explanation is omitted here.

Further, the optical module B2 for 2ch has the structure of removing fifth and sixth V-grooves 65, 66, fifth and sixth fiber collimators 105, 106, wavelength selective filters 73, 74, optical path correcting board 82, and mirror 92, from the structure of the aforementioned optical module B3 for 4ch.

<Manufacturing Procedure of Optical Module B3 (Including B2)>

The aforementioned optical module B3 for 4ch can be manufactured as follows.

First, the first and second V-grooves 61, 62, and the third and sixth V-grooves 63 and 66 are formed in parallel to each other on the same axial line, respectively, and further the fifth V-groove 65 is formed in parallel to the third V-groove 63, and the substrate 50 formed with the fourth V-groove 64 in parallel to the second and sixth V-grooves 62 and 66 is prepared between the second and sixth V-grooves 62 and 66. In the center of the substrate 50, the optical element disposal face 51 recessed by one step from the right and left collimator disposal faces 52 and 53 is formed.

The dimension of the substrate 50 in this case is 40×14×3 mm, and six V-grooves 61 to 66 in total are disposed in parallel to each other and cut to the same depth, for every three of them at some interval apart on the collimator disposal faces 52 and 53 with lateral width set at 9 mm. In addition, the central optical element disposal face 51 has undergone surface grinding to width of 21 mm. Here, the facing V-grooves 61, 62, and the V-grooves 63, 66 can be machined by cutting, thus easily realizing high precision processing.

After the substrate 50 is prepared, next, in the same way as the case of the optical module A (see FIG. 1), the optical fiber terminal 110 and the collimator lens 120 are respectively disposed in the first and second V-grooves 61 and 62 to adjust the position, and the first and second fiber collimators 101 and 102 are thereby created. Subsequently, on the light path between the first fiber collimator 101 and the second fiber collimator 102, the first wavelength selective filter 71 is disposed at a previously designed angle, and the optical path correcting board 81 for correcting the optical path deviation caused by the first wavelength selective filter 71 is disposed at an angle symmetrical with the first wavelength selective filter 71.

Next, the optical fiber terminal 110 and the collimator lens 120 are disposed in the third V-groove 63 adjacent to the first V-groove 61 to temporarily assemble the third fiber collimator 103, and the fiber terminal 110 and the collimator lens 120 are disposed in the fourth V-groove 64 to temporarily assemble the fourth fiber collimator 104. In addition, the second wavelength selective filter 72 is disposed at an intersecting point of an optical axis of the light reflected by the first wavelength selective filter 71 and extension line of the axis of the fourth V-groove 64, so that the lights sequentially reflected by the first wavelength selective filter 71 and the second wavelength selective filter 72 can be made incident to the fourth fiber collimator 104.

Next, the lights of the wavelengths reflected by the first and second wavelength selective filters 71 and 72 are made incident to the first fiber collimator 101, and the position and the direction of the second wavelength selective filter 72 and the distance between the optical fiber terminal 110 and the collimator lens 120 constituting the fourth fiber collimator 104 are determined and fixed, while confirming the amount of the light that is coupled to the optical fiber terminal 110 of the fourth fiber collimator 104 through the wavelength selective filters 71 and 72.

Next, the mirror 91 is disposed in front of the third fiber collimator 103, and in this state, the light of the wavelength that is reflected by the first wavelength selective filter 71 and transmits through the second wavelength selective filter 72 is made incident to the first fiber collimator 101, and the position and the direction of the mirror 91 and the distance between the fiber terminal 110 and the collimator lens 120 constituting the third fiber collimator 103 are determined and fixed, while confirming the amount of the light that is reflected by the first wavelength selective filter 71 and transmits through the second wavelength selective filter 72 and is coupled to the third fiber collimator 103.

The optical module B2 for 2ch of FIG. 6 is completed in the steps so far, and therefore when the optical module B2 for 2ch is created, the processing is finished in the steps so far. When the optical module B3 for 4ch is created, further steps thereafter is continued.

When the optical module B3 for 4ch is created, following the previous step, the third wavelength selective filter 73 is disposed at a previously designed angle on the light path of the light that is reflected by the second wavelength selective filter 72 and is made incident to the fourth fiber collimator 104, and the optical path correcting board 82 for correcting the optical path deviation caused by the third wavelength selective filter 73 is disposed between the third wavelength selective filter 73 and the fourth fiber collimator 104 at an angle symmetrical with the third wavelength selective filter 73.

Next, the fiber terminal 110 and the collimator lens 120 are disposed in the fifth V-groove 65, the fifth fiber collimator 105 is temporarily assembled, and the fiber terminal 110 and the collimator lens 120 are disposed in the sixth V-groove 66, and the sixth fiber collimator 106 is temporarily assembled. In addition, the fourth wavelength selective filter 74 is disposed at the intersecting point of the optical axis of the light reflected by the third wavelength selective filter 73 and the extension line of the axis of the sixth V-groove 66, and the light sequentially reflected by the first wavelength selective filter 71, the second wavelength selective filter 72, the third wavelength selective filter 73, and the fourth wavelength selective filter 74 is made incident to the sixth fiber collimator 106.

Next, the light of the wavelength that is reflected by the first, second, third, fourth wavelength selective filters 71, 72, 73, 74 is inputted to the first fiber collimator 101, and the position and the direction of the fourth wavelength selective filter 74 and the distance between the optical fiber terminal 110 and the collimator lens 120 constituting the sixth fiber collimator 106 are determined and fixed, while confirming the amount of the light that is sequentially reflected by the wavelength selective filters 71, 72, 73, 74 and coupled to the optical fiber terminal 110 of the sixth fiber collimator 106.

Next, the mirror 92 is disposed in front of the fifth fiber collimator 105, and in this state, the light of the wavelength that is reflected by the first, second, third wavelength selective filters 71, 72, 73, and transmits through the fourth wavelength selective filter 74 is inputted, and the position and direction of the mirror 92 and the distance between the optical fiber terminal 110 and the collimator lens 120 constituting the fifth fiber collimator 105 are determined and fixed, while confirming the amount of the light that is sequentially reflected by the first, second, third wavelength selective filters 71, 72, 73, transmitted through the fourth wavelength selective filter 74 and coupled to the fifth fiber collimator 105 through the mirror 92. Thus, the optical module B3 is completed.

As described above, the explanation has been given to a case of manufacturing the optical modules B2 and B3 for 2ch and 4ch. However, the optical module having the number of channels beyond 4ch can also be easily manufactured by repeating the same procedure.

Note that a wavelength selective filter (WDM filter) with a dimension of 1.4×1.4×1.2 mm designed to transmit the lights having the wavelengths of 1511, 1531, 1551, and 1571 nm and reflect the light of other wavelengths is given as an example of the wavelength selective filters 71 to 74 used as described above.

In addition, an optical correcting board, which is a parallel flat-shaped glass substrate applied with an anti-reflection film on both sides, designed to have substantially the same material and dimension as those of the substrate of the wavelength selective filter disposed just before and suppress the reflectance of the light having the wavelengths of 1450 to 1650 to 0.2% or less, is given as an example of the optical correcting boards 81 and 82.

In addition, as the mirrors 91 and 92 for correcting the optical path, it is suitable to use a metal mirror formed of aluminum and gold from the point of having excellent reflectance and durability, and mirror having a size of 2×5×1 mm and obtained by adding a film of aluminum and magnesium fluoride to the glass substrate can be given as an example.

The optical modules B2 and B3 for 2ch or more can be used as a multi-channel type optical demultiplexer or optical multiplexer. In addition, usually the multiplexer/demultiplexer of a plurality of wavelengths usually manufactured by connecting a plurality of 1-channel type multiplexers/demultiplexers is constituted on the assumption that each constituent component such as a collimator and a wavelength selective filter is integrated and deployed on the same substrate, and the optical space transmission occurs between each component. Therefore, a small-sized optical wavelength multiplexer/demultiplexer with low loss can be easily obtained without using a useless component, with a minimum necessary volume.

In addition, as each collimator, by using the fiber collimators 101 to 106 composed of a combination of the optical fiber terminal and the collimator lens adapted to lessen an optical axis deviation by arranging the coreless fiber on the tip so as to realize a sufficient reflection attenuation amount, it is possible to provide the multi-channel type optical module easy to be assembled, capable of obtaining an optical coupling of high efficiency among fiber collimators 101 to 106, and suitable for obtaining the optical multiplexer/demultiplexer with low loss.

Particularly, in this case, the single mode optical modules B2 and B3 are used exclusively for either one of the optical demultiplexing or optical multiplexing, and therefore no problem is arises, such that the insert light that inserts toward the wavelength selective filter for multiplexing is mixed in demultiplexed branching light.

Next, explanation will be given to a case of using these optical modules B2, B3 as the optical wavelength demultiplexing device for 2ch and 4ch by using FIG. 7(a) and FIG. 9(a).

<When the Optical Module B2 is Used as the Optical Wavelength Demultiplexing Device>

First, explanation will be given to a case of using the optical module B2 for 2ch as the optical wavelength demultiplexing device.

In this case, as shown in FIG. 7(a), the first fiber collimator 101 on the uppermost stream side in a traveling direction of light is used as the collimator (In) for input light whereby the wavelength multiplexing light (including wavelength of λ1 and λ2) sent from the external light transmission path 1001 for input is made incident to the wavelength selective filter 71 on the uppermost stream side as input light, and the fourth fiber collimator 104 on the lowermost stream side is used as the collimator for output (Out) for sending the light reflected by the wavelength selective filter on the lowermost stream side to the external light transmission path 1004 for output, and other second and third fiber collimators 102 and 103 are used as the collimator for branching light (Drop) for extracting the light (light with the wavelengths of λ1 and λ2), that transmits through each wavelength selective filter 71, 72, to the external transmission paths 1002 and 1003. Thus, the function of sequentially demultiplexing the wavelength multiplex light (demultiplexing a light signal with the wavelengths of λ1 and λ2) can be exhibited.

<When the Optical Module B3 is Used as the Optical Wavelength Demultiplexing Device>

Next, explanation will be given to a case of using the optical module B3 for 4ch as the optical wavelength demultiplexing device.

In this case, as shown in FIG. 9(a), the first fiber collimator 101 on the uppermost stream side in the traveling direction of light is used as the collimator for input (In) whereby the wavelength multiplex light (including λ1 to λ4) sent from the external light transmission path 1001 for input is made incident to the wavelength selective filter 71 on the uppermost stream side, and the sixth fiber collimator 106 on the lowermost stream side is used as the collimator for output (Out) for sending the light reflected by the wavelength selective filter 74 on the lowermost stream side to the external light transmission path 1006 for output, and other second to fifth fiber collimators 102 to 105 are used as the collimator for branching light (Drop) for extracting the lights (lights with the wavelength of λ1 to λ4) that transmit through each wavelength selective filters 71 to 74 to external transmission paths 0002 to 1005. Thus, the function of sequentially demultiplexing the wavelength multiplex light (demultiplexing the light signal with the wavelengths of λ1 to λ4) can be exhibited.

For example, when wavelength multiplex signals including the wavelengths of λ1=1511, λ2=1531, λ3=1551, λ4=1571, and λ5=1591 nm are inputted in the optical fiber terminal 110 of the first fiber collimator 101 for input/output, only the light with the wavelength of λ1=1511 nm transmits though the first wavelength selective filter 71 and is coupled to the optical fiber terminal 110 of the second fiber collimator 102 for demultiplexing. Other lights with the wavelengths of λ2=1531, λ3=1551, λ4=1571, λ5=1591 nm are reflected toward the second wavelength selective filter 72.

Similarly, only the light with the wavelength of λ2=1531 nm transmits through the second wavelength selective filter 72, and is coupled to the optical fiber terminal 110 of the third fiber collimator 103 for demultiplexing, and other lights with the wavelengths of λ3=1551, λ4=1571, λ5=1591 nm are reflected toward the third wavelength selective filter 74.

Only the light with the wavelength of λ3=1551 transmits through the third wavelength selective filter 73 and is coupled to the optical fiber terminal 110 of the fourth fiber collimator 104 for demultiplexing, and other lights with the wavelengths of λ4=1571, λ5=1591 nm are reflected toward the fourth wavelength selective filter 74.

Only the light with the wavelength of λ4=1571 nm transmits through the fourth wavelength selective filter 74, and is coupled to the optical fiber terminal 110 of the fifth fiber collimator 105 for demultiplexing, and other light with the wavelength of λ5=1591 nm is reflected toward the sixth fiber collimator 106. Thus, the light of each wavelength is sequentially demultiplexed.

Actually, by using a wavelength variable laser as a light source, the wavelength multiplex lights with the wavelengths of 1511, 1531, 1551, 1571, and 1591 nm are inputted in the optical fiber terminal 110 of the first fiber collimator 101, and an insertion loss is obtained by measuring a light intensity of each wavelength of the light demultiplexed and emitted to the optical fiber terminal 110 of each of the fiber collimators 102 to 106. Then, the insertion loss of 0.6 dB or less is obtained in all channels.

In addition, when a reflection attenuation amount of each fiber terminal is measured for the light with the wavelength of 1550 nm by using a reflection attenuation amount measuring machine of a system of comparing a return light at the time of terminating an outgoing end from a generally used incorporated light source and a return light at the time of connecting a measuring object to a fiber terminal, the reflection attenuation amount of 50 dB or more generally required by the optical module is obtained in all the fiber terminals.

As described above, according to the embodiments of the present invention, the optical demultiplexing device can be obtained, which is capable of realizing a low insertion loss while satisfying a sufficient reflection attenuation amount, by only using a small-sized substrate of 40×14 mm and performing assembly by easy positioning.

Next, explanation will be given to a case of using the optical modules B2 and B3 as the optical wavelength multiplexing and demultiplexing devices for 2ch and 4ch, by using FIG. 7(b) and FIG. 9(b).

<When the Optical Module B2 is Used as the Optical Wavelength Multiplexing Device>

First, explanation will be given to a case of using the optical module B2 for 2ch as the optical wavelength multiplexing device.

In this case, as shown in FIG. 7(b), the fourth fiber collimator 104 on the uppermost stream side in the traveling direction of the light at the time of multiplexing is used as the collimator for input light (In) whereby the light sent from the external light transmission path 1004 for input is made incident to the surface of the second wavelength selective filter 72 on the uppermost stream side as input light, and the first fiber collimator 101 on the lowermost stream side is used as the collimator for output (Out) for sending the multiplex light of the reflected light reflected by the first wavelength selective filter 71 on the lowermost stream side and the insert light that transmits through the first wavelength selective filter 71 to the external light transmission path 1001 for output, and other third and second fiber collimators 103 and 102 are used as the collimator (Add) for insert light whereby the insert light with specific wavelength of λ2 and λ1 of each filter 71 and 72 is made incident to the backside of each wavelength selective filter 72 and 71 from the external transmission paths 1003 and 1002 for insert light. Thus, the function of sequentially multiplexing the lights of different wavelengths (light with the wavelengths of λ1 and λ2) can be exhibited.

<When the Optical Module B3 is Used as the Optical Wavelength Multiplexing Device>

Next, explanation will be given to a case of using the optical module B3 for 4ch as the optical wavelength multiplexing device.

In this case, as shown in FIG. 9(b), the sixth fiber collimator 106 on the uppermost stream side in the traveling direction of the light at the time of multiplexing is used as the collimator (In) for input whereby the light sent from the external light transmission path 1006 is made incident to the surface of the fourth wavelength selective filter 74 on the uppermost stream side as input light, and the first fiber collimator 101 on the lowermost stream side is used as the collimator for output (Out) for sending the multiplex lights of the reflected light reflected by the first wavelength selective filter 71 on the lowermost stream side and the insert light that transmits through the first wavelength selective filter 71 to the light transmission path 1001 for output, and other fifth, fourth, third, and second fiber collimators 105, 104, 103, and 102 are used as the collimator (Add) for insert light whereby the insert light with specific wavelength bands λ4, λ3, λ2, λ1 of each filter 74, 73, 72, 71 is made incident to the backside of each of the wavelength selective filters 74, 73, 72, 71 from the external transmission paths 1005, 1004, 1003, 1002 for insert light. Thus, the function of sequentially multiplexing the lights of different wavelengths (light with the wavelengths of λ1 to λ4) can be exhibited.

For example, when lights with the wavelengths of λ1=1511, λ2=1531, λ3=1551, λ4=1571, and λ5=1591 nm are inputted to the fiber collimators 106 to 102 for input and for sequentially insert, the lights with the wavelengths of λ4=1571, and λ5=1591 nm are multiplexed in the fourth wavelength selective filter 74, the lights with the wavelengths of λ3=1551, λ4=1571, and λ5=1591 nm are multiplexed in the third wavelength selective filter 73, the lights with the wavelengths of λ2=1531, λ3=1551, λ4=1571, and λ5=1591 nm are multiplexed in the second wavelength selective filter 72, and the lights with the wavelengths of λ1=1511, λ2=1531, λ3=1551, λ4=1571, and λ5=1591 nm are multiplexed in the first wavelength selective filter 71. Then, the wavelength multiplex light (λ1 to λ5) emitted from the first wavelength selective filter 71 is coupled to the optical fiber terminal 110 of the fiber collimator 101 for input/output and is sent to the external light transmission path 1001 for output.

As described above, the optical modules B2 and B3 according to the embodiment of the present invention can be used as the optical demultiplexing device, and also can be used as the optical multiplexing device. The insertion loss and reflection attenuation in this case show the same values as those when the optical module is used as the optical demultiplexing device.

In addition, these optical modules B2 and B3 are so constructed that each component is disposed on the substrate 50 so as to allow the optical space transmission to be performed. Therefore, if compared to the optical demultiplexing device or the optical multiplexing device of the type of connecting inter-filter modules by optical fiber using a plurality of filter modules as is conventionally done, small-sized, inexpensive optical demultiplexing device or the optical multiplexing device with low loss can be obtained. Particularly, as the number of channels is increased, the optical module of this embodiment can exhibit a merit. In the aforementioned example, the modules having channels of 2ch and 4ch are shown, but in a case of a module having more channels also, it can be developed by repeating the above-described procedures.

<Regarding the Optical Module of Series C>

Next, the optical module of series C will be explained.

In optical modules C1 to C3 of series C as shown in FIG. 10 to FIG. 12, only the third V-groove 63 and fifth V-groove 65 on the same side as the first V-groove 61 are formed at a prescribed angle not parallel to the first V-groove 61. The other constitution corresponds to the optical modules B1 to B3 of B series, and therefore detailed explanation is omitted.

### Regarding Optical Module C1 (Fifth Embodiment)

A characteristic point of the optical module C1 for 1ch of FIG. 10 is that the third V-groove 63 is formed at an angle so that the third fiber collimator 103 is positioned on the straight line in the traveling direction of the light made incident from the first fiber collimator 101 and reflected by the wavelength selective filter 70. In this way, the optical path needs not to be bent, and therefore the mirror being the optical path correcting means (see FIG. 4) can be omitted.

### Regarding Optical Module C2 (Sixth Embodiment)

The characteristic point of the optical module C2 for 2ch of FIG. 11 is that the third V-groove 63 is formed at an angle so that the third fiber collimator 103 is positioned on the straight line in the traveling direction of the light made incident from the first fiber collimator 101 and reflected by the first wavelength selective filter 71, and since the second wavelength selective filter 72 is disposed on the light path between the first wavelength selective filter 71 and the third fiber collimator 103, not the mirror but the optical path correcting board 82 for correcting the optical path deviation caused by the second wavelength selective filter 72 is disposed between the third fiber collimator 103 and the second wavelength selective filter 72.

### Regarding Optical Module C3 (Seventh Embodiment)

The characteristic point of the optical module C3 for 4ch of FIG. 12 is that the third V-groove 63 is formed at an angle so that the third fiber collimator 103 is positioned on the straight line in the traveling direction of the light made incident from the first fiber collimator 101 and reflected by the first wavelength selective filter 71, and the fifth V-groove 65 is formed at an angle so that the fifth fiber collimator 105 is positioned on the straight line in the traveling direction of the light made incident from the first fiber collimator 101 and sequentially reflected by the first wavelength selective filter 71, the second wavelength selective filter 72, and the third wavelength selective filter 73 (in this case, the third and fifth V-grooves 63 and 65 are formed in parallel to each other), and not the mirror but the optical path correcting boards 82 and 84 for correcting the optical path deviation respectively caused by the second and fourth wavelength selective filters 72 and 74 are disposed between the third fiber collimator 103 and the second wavelength selective filter 72, and between the fifth fiber collimator 105 and the fourth wavelength selective filter 74.

The optical modules C1 to C3 of C-series can be used completely in the same way as the optical modules B1 to B3 of B series. Accordingly, the explanation of the usage is omitted.

Next, the manufacturing method of the optical modules C1 to C3 of C-series will be explained. Note that the optical module C1 for 1ch and the optical module C2 for 2ch, are made in a process half of the manufacturing method of the optical module C3 for 4ch. Therefore, the manufacturing method of only optical module C3 for 4ch will be explained on behalf of the optical module C1 and the optical module C2.

<Manufacturing Method of the Optical Module C3>

The optical module C3 as shown in FIG. 12 can be manufactured as follows.

First, the substrate 50 formed with first to sixth six V-grooves 61 to 66 is prepared. Here, odd-numbered first, third, and fifth V-grooves 61, 63, 65 are formed on the collimator disposal face 52 of one side of the substrate 50, and even-numbered second, fourth, and sixth V-grooves 62, 64, 66 are formed on the collimator disposal face 53 of the other side of the substrate 50. These V-grooves 61 to 66 are formed so as to be arranged on the same plane.

The first V-groove 61, the second V-groove 62, the fourth V-groove 64, and the sixth V-groove 66 are mutually parallel and particularly the first V-groove 61 and the second V-groove 62 are disposed on the same axis. The third V-groove 63 is formed so as to cross the first V-groove 61 at a designated angle and place. Also, the fifth V-groove 65 is formed so as to be parallel to the third V-groove 63 and cross the fourth V-groove 64 at the designated angle and place.

The optical element disposal face 51 of the center of the substrate 50 is formed to be a height, so as to align the optical axis of the fiber collimators 101 to 106 disposed in the V-grooves 61 to 66 of both sides, and the center of the optical element disposed on the optical element disposal face 51. The dimension of the substrate 50 in this case is 35×17×3 mm, and the collimator disposal faces 52 and 53 having a width of 9 mm are formed on both ends. Then, three V-grooves 61 to 66 of the same depths are formed on the right and left collimator disposal faces 52 and 53, and an interval between parallel V-grooves 62, 64, and 66 is set at 3 mm. In addition, the optical element disposal face 51 with center width of 17 mm is formed by surface grinding. Such a shape of the substrate 50 slightly increases a processing cost by an amount of obliquely processing the V-grooves 63 and 65. However, the merit in this case is that the substrate 50 can be made small.

After the aforementioned substrate 50 is prepared, the optical fiber terminal 110 and the collimator lens 120 are disposed in the first and second V-grooves 61 and 62, and the first and second fiber collimators 101 and 102 are manufactured. A method of manufacture is completely the same as that explained for the optical module A, and therefore the explanation therefore is omitted here.

Next, the optical fiber terminal 110 and the collimator lens 120 are disposed in the third V-groove 63, and the wavelength selective filter 71 is disposed on the point where the third V-groove 63 and the extension of the axial line of the first and second V-grooves 61 and 62 cross on the substrate 50, and either one of the optical fiber terminal 110 or the collimator lens 120 in the V-groove 63 is fixed.

In this state, the light of the wavelength that reflects by the first wavelength selective filter 71 from the first fiber collimator 101 is inputted, which is then reflected by the first wavelength selective filter 71, and while confirming the amount of light made incident to the optical fiber terminal 110 on the third V-groove 61, the position and direction of the first wavelength selective filter 71 are adjusted. Simultaneously, the distance between the optical fiber terminal 110 and the collimator lens 120 on the third V-groove 63 is determined and fixed, and the third fiber collimator 103 is manufactured.

At this time, the first wavelength selective filter 71 can be disposed at a position capable of easily obtaining the optical coupling, because the precision of the optical axis of each of the first and third fiber collimators 101 and 103 is maintained sufficiently high. In addition, the first and third V-grooves 61 and 63 are on the same plane, and all optical axes of the fiber collimators 101 and 103 in the V-grooves 61 and 63 do not move out of this plane, and therefore the optical coupling with low loss can be obtained by two-dimensional optical axis adjustment by one wavelength selective filter 71.

Next, the optical path correcting board 81 of the same characteristic as the first wavelength selective filter 71 is disposed at an angle symmetrical with the first wavelength selective filter 71, between the first wavelength selective filter 71 and the second fiber collimator 102. At this time, the light of the wavelength that transmits through the first wavelength selective filter 71 is made incident to the first fiber collimator 101, and by measuring the amount of the light outputted from the second fiber collimator 102, the optical path correcting board 81 is slightly adjusted and fixed.

Next, the optical fiber terminal 110 and the collimator lens 120 are disposed in the fourth V-groove 64, and at the point where the third V-groove 63 and the extension of the axial line of the fourth V-groove 64 cross on the substrate 50, the second wavelength selective filter 72 is disposed, and either one of the optical fiber terminal 110 or the collimator lens 120 in the fourth V-groove 64 is fixed.

Next, in this state, the light of the wavelength that reflects by the first wavelength selective filter 71 and the second wavelength selective filter 72 is made incident to the first fiber collimator 101, and while confirming the amount of the light sequentially reflected by the wavelength selective filters 71 and 72 and made incident to the optical fiber terminal 110 on the fourth V-groove 64, the position and direction of the second wavelength selective filter 72 and the distance between the optical fiber terminal 110 and the collimator lens 120 on the fourth V-groove 64 are determined and fixed, and the fourth fiber collimator 104 is manufactured.

Next, the optical path correcting board 82 of the same characteristic as that of the second wavelength selective filter 72 is disposed at an angle symmetrical with the second wavelength selective filter 72, between the second wavelength selective filter 72 and the third fiber collimator 103. At this time, the light of the wavelength that reflects by the first wavelength selective filter 71 and transmits through the second wavelength selective filter 72 is made incident to the first fiber collimator 101, and while confirming the amount of the light made incident to the optical fiber terminal 110 on the third V-groove 63, the optical path correcting board 82 is slightly adjusted and fixed.

Next, the optical fiber terminal 110 and the collimator lens 120 are disposed in the fifth V-groove 65, and at the point where the fifth V-groove 65 and the extension of the axial line of the V-groove 64 cross on the substrate 50, the third wavelength selective filter 73 is disposed, and either one of the optical fiber terminal 110 or the collimator lens 120 on the fifth V-groove 65 is fixed.

In this state, the light of the wavelength that reflects by the first, second, and third wavelength selective filter 71, 72, 73 is made incident from the first fiber collimator 101, and is sequentially reflected by the first, second, and third wavelength selective filter 71, 72, and 73, and while confirming the amount of the light made incident to the optical fiber terminal 110 on the fifth V-groove 65, the position and direction of the third wavelength selective filter 73 is adjusted. Simultaneously, the distance between the optical fiber terminal 110 and the collimator lens 120 on the fifth V-groove are determined and fixed, and the fifth fiber collimator 105 is manufactured.

Next, the optical path correcting board 83 for correcting the optical path deviation caused by the third wavelength selective filter 71 is disposed at an angle symmetrical with the third wavelength selective filter 73, between the third wavelength selective filter 73 and the fourth fiber collimator 104. At this time, the light of the wavelength that reflects by the first and second wavelength selective filters 71 and 72 and transmits through the third wavelength selective filter 73 is made incident to the first fiber collimator 101, and by measuring the amount of the light made incident to the optical fiber terminal 110 of the fourth fiber collimator 104, the optical path correcting board 83 is slightly adjusted and fixed.

Next, the optical fiber terminal 110 and the collimator lens 120 are disposed in the sixth V-groove 66, and at the point where the fifth V-groove 65 and the extension of the axial line of the V-groove 66 cross on the substrate 50, the fourth wavelength selective filter 74 is disposed, and either one of the optical fiber terminal 110 or the collimator lens 120 on the sixth V-groove 66 is fixed.

Next, in this state, the light of the wavelength that reflects by the first, second, third, and fourth wavelength selective filters 71, 72, 73, and 74 is made incident to the first fiber collimator 101, and while confirming the amount of the light sequentially reflected by the wavelength selective filters 71, 72, 73, 74 and made incident to the optical fiber terminal 110 on the sixth V-groove 66, the position and direction of the fourth wavelength selective filter 74, and the distance between the optical fiber terminal 110 and the collimator lens 120 on the sixth V-groove 66 are determined and fixed, and the sixth fiber collimator 104 is manufactured.

Next, the optical path correcting board 84 of the same characteristic as that of the fourth wavelength selective filter 74 is inserted and disposed at an angle symmetrical with the fourth wavelength selective filter 74, between the fourth wavelength selective filter 74 and the fifth fiber collimator 105. At this time, the light that reflects by the first, second, third wavelength selective filters 71, 72, 73 and transmits through the wavelength selective filter 74 is made incident to the first fiber collimator 101, and by measuring the amount of the light made incident to the optical fiber terminal 110 on the fifth V-groove 65, the optical path correcting board 84 is slightly adjusted and fixed.

As described above, the position of all the members are determined and fixed, and the small-sized optical module C3 having the optical multiplex/demultiplexing function capable of being easily assembled with low loss can be manufactured.

In the above-described manufacturing step, in order to perform positioning of each member, the light is inputted to the first fiber collimator 101 and the position is adjusted by measuring the amount of the light outputted from the optical fiber terminal 110 of each of the fiber collimators 102 to 106. However, test light is inputted from the fiber collimator that has already undergone positioning other than the first fiber collimator 101, and the positional adjustment can be performed for the component on the lower stream side. Also, arrangement of all the members can be performed by a mechanical operation, with an image processing and an external shape set as a reference.

<Regarding a Combination of a Plurality of Optical Modules>

As described above, each of the single mode optical modules is respectively explained. Next, the explanation will be given to a case of combining the aforementioned optical modules to be used as the optical wavelength multiplexing and demultiplexing device. Here, by way of example, the explanation is given to the optical wavelength multiplexing and demultiplexing device for 1ch wherein a pair of optical modules B1 (two optical modules B1) for 1ch of B series is used, and a case of the optical wavelength multiplexing and demultiplexing device for 4ch wherein a pair of optical modules B3 (two optical modules B3) for 4ch is used.

<Regarding Optical Wavelength Multiplexing and Demultiplexing Device for 1ch>

FIG. 13 shows a constitution of the optical wavelength multiplexing and demultiplexing device for 1ch constituted by using two optical modules B1 for 1ch. An optical module B1a on the left side of figure is used as the optical wavelength multiplexer and an optical module B1b on the right side is used as the optical wavelength multiplexer. Although right and left optical modules B1a and B1b produce a symmetrical appearance, it may also be so constituted that the same optical module B1 is connected so as to function in the same way as shown in the figure.

When a signal processing of 1ch is performed, the first fiber collimator 101 is set as an input port (In), the second fiber collimator 102 is set as a branching port (Drop), and the third fiber collimator is set as an output port (Out) in the optical module B1a on the side of the demultiplexer.

In addition, the first fiber collimator 101 is set as the output port (Out), the second fiber collimator 102 is set as an insertion port (Add), and the third fiber collimator 103 is set as an input port (In) in the optical module B1b on the side of the multiplexer.

Then, the light transmission path 1001 of the input port (the first fiber collimator 101) on the side of the demultiplexer is connected to the external transmission path, the light transmission path 1002 of the branching port (the second fiber collimator 102) is connected to an optical switch 2000, and the light transmission path 1003 of the output port (the third fiber collimator 103) is connected to the light transmission path 1003 of the input port (the third fiber collimator 103) of the optical module B1b on the side of the demultiplexer/demultiplexer.

In addition, in the optical module B1b of the side of the demultiplexer/multiplexer, the light transmission path 1002 of the insertion port (the second fiber collimator 102) is connected to the optical switch 2000, and the light transmission path 1002 of the output port (the first fiber collimator 101) is connected to the external transmission path. Thus, the optical wavelength multiplexing and demultiplexing device is completed.

In the optical wavelength multiplexing and demultiplexing device, the optical signal other than that of a particular wavelength multiplexed/demultiplexed by the wavelength selective filter 70 out of the wavelength multiplex signals inputted to the input port (the first fiber collimator 101) of the optical module B1a on the side of the demultiplexer from the external transmission path is reflected by the wavelength selective filter 70, and is inputted to the input port (the third fiber collimator 103) of the optical module B1b on the side of the multiplexer from the output port (the third fiber collimator 103) and is reflected by the wavelength selective filter 70, then is outputted form the output port (the first fiber collimator 101) and is returned to the external transmission path.

Meanwhile, the optical signal of a particular wavelength multiplexed/demultiplexed by the wavelength selective filter 70 is extracted from the branching port (the second fiber collimator 102) of the optical module B1a on the side of the demultiplexer, and thereafter is inputted to the optical switch 2000. When extracting and replacing of signals is not needed, in the optical switch 2000, the signal is allowed to pass through as it is, and is inputted to the insertion port (the second fiber collimator 102) of the optical module B1b on the side of the multiplexer. The optical signal of a particular wavelength introduced from the insertion port (the second fiber collimator 102) can transmit through the wavelength selective filter 70, and therefore it is multiplexed with the signal of other wavelength that is reflected by the surface of the wavelength selective filter 70, and is returned to an original transmission path from the output port (the first fiber collimator 101).

When the extracting and replacing of the signal of a particular wavelength is needed, the signal is extracted outside from a Drop port by the optical switch 2000, and after a necessary signal processing is applied thereto, it is returned to the original transmission path through the insertion port of the optical module B1b on the side of the multiplexer from the Add port.

<Regarding the Optical Wavelength Multiplexing and Demultiplexing Device for 4ch>

FIG. 14 shows a constitution of an optical wavelength multiplexing and demultiplexing device for 4ch constituted by using two optical modules B3 for 4ch. An optical module B3a on the left side of the figure is used as the optical wavelength demultiplexer, and an optical module B3b on the right side is used as the optical wavelength multiplexer. Although left and right optical modules B3a and B3b produce a symmetrical appearance in the figure, the same optical module B3 can be connected so as to function in the same as that as shown in the figure.

When the signal processing of 4ch is performed, the first fiber collimator 101 of the optical module B3a on the side of the demultiplexer is set as the input port (In), the second to fifth fiber collimators 102 to 105 are set as the branching port (Drop), and the sixth fiber collimator 106 is set as the output port (Out).

Also, the first fiber collimator 101 of the optical module B3b on the side of the multiplexer is set as the output port (Out), the second to fifth fiber collimators 102 to 105 are set as the insertion port (Add), and the sixth fiber collimator 103 is set as the input port (In).

Then, the light transmission path 1001 of the input port (the first fiber collimator 101) of the optical module B3a on the side of the demultiplexer is connected to the external transmission path, the light transmission paths 1002 to 1005 of the branching port (the second to fifth fiber collimators 102 to 105) are connected to the optical switch 2000, the light transmission path 1006 of the output port (the sixth fiber collimator 106) is connected to the light transmission path 1006 of the input port (the sixth fiber collimator 106) of the optical module B3b on the side of the demultiplexer/multiplexer.

Also, in the optical module B3b on the side of the demultiplexer/multiplexer, the light transmission paths 1002 to 1005 of the insertion port (the second to fifth fiber collimators 102 to 105) are connected to the optical switch 2000, and the light transmission path 1001 of the output port (the first fiber collimator 101) is connected to the external transmission path. Thus, the optical wavelength multiplexing and demultiplexing device as a system is completed.

In this optical wavelength multiplexing and demultiplexing device, when the wavelength multiplex signal from the external transmission path is inputted to the input port of the optical module B3a on the side of the demultiplexer, the signal other than that of a particular wavelength multiplexed/demultiplexed by total wavelength selective filters 71 to 74 is reflected by the wavelength selective filters 71 to 74, then is outputted from the output port of the optical module B3b on the side of the multiplexer, and is returned to the external transmission path.

Meanwhile, each optical signal of a particular wavelength multiplexed/demultiplexed by the wavelength selective filters 71 to 74 is demultiplexed by each wavelength selective filter 71 to 74 of the optical module B3a on the side of the demultiplexer and is extracted for every wavelength, and is inputted to the optical switch 2000 for every wavelength. In the optical switch 2000, when the extracting and replacing of the signal is not needed, the signal is allowed to pass through as it is, then is multiplexed again in the optical module B3b on the side of the multiplexer/demultiplexer, and is returned to the external transmission path from the output port. Also, when the extracting and replacing of the signal is needed, the signal is extracted outside from the Drop port by the optical switch 2000, and after a necessary signal processing is applied thereto, it is returned to the original transmission path from the Add port through the insertion port of the optical module B3b on the side of the multiplexer.

As described above, the optical wavelength multiplexing and demultiplexing device is constituted by combining two optical modules B1 and B3 of the same type separately in function, such as one for exclusively for demultiplexer, and the other for exclusively for multiplexer. Therefore, differently from a case that one wavelength selective filter is shared by demultiplexing and multiplexing, there is no possibility that the insert light is mixed in the branching light, thus making it possible to prevent a signal deterioration.

### Regarding Optical Modules D1 and D2 (Embodiments 8 and 9) of Series D

Next, explanation will be given to optical modules D1 and D2 of series D adapted to perform demultiplexing and multiplexing in the same module. Here, the explanation is given by defining the optical module D1 for 1ch as an embodiment 8, and the optical module D2 as an embodiment 9.

In a general communication system, the multiplexing and demultiplexing are frequently performed in the same place or in a close proximity place. For example, when the wavelength branching and insertion of a conventional 2 channel is performed, it was necessary that the demultiplexer of 2 channel and the multiplexer of 2 channel were separately prepared, and as shown in FIG. 17, by mutually connecting them through the optical fiber, the system was constituted. In such a scene, the optical modules D1 and D2 of this embodiment exhibit advantages. Namely, in the optical modules D1 and D2 of this embodiment, the function of demultiplexing and multiplexing can be performed on the same substrate, and thus a fiber connecting portion of an intermediate part and a collimator and a case, etc, for fiber connection can be omitted, thereby realizing the small-sized low loss optical wavelength multiplexing and demultiplexing device at a low cost.

Hereunder, the explanation will be given individually to the optical module D1 for 1ch and the optical module D2 for 2ch in series D.

### Regarding Optical Module D1 (Embodiment 8)

FIG. 15 shows the constitution of the optical module D1 used as the optical wavelength multiplexing and demultiplexing device for 1ch.

This optical module D1 includes the constitution of a previously explained optical module A as a basic element. As the constitution of a part corresponding to the optical module A, the first fiber collimator 101 and the second fiber collimator 102 are respectively disposed on the collimator disposal faces 52 and 53 of both sides of the substrate 50. These first and second fiber collimators 101 and 102 are respectively disposed in the first V-groove 61 and the second V-groove 62 formed on the same axial line. Then, a wavelength selective filter 70(A) for demultiplexing that allows only the light of a particular wavelength to transmit and reflects the light of other wavelength is disposed on the light path between the first and second fiber collimators 101 and 102, and the optical path correcting board 80 that corrects the optical deviation due to the wavelength selective filter 70(A) is disposed at an angle symmetrical with the wavelength selective filter 70(A), between the wavelength selective filter 70(A) and the second fiber collimator 102.

Further, in addition to the constitution of the part corresponding to the optical module A, the fourth V-groove 64 is formed in parallel to the first V-groove 61, and the third V-groove 63 is formed on other collimator disposal face 53 in parallel to the second V-groove 61. The third and fourth V-grooves 63 and 64 are formed on the same axial line, and the third and fourth fiber collimators 103 and 104 are respectively disposed in each V-groove 63, 64.

In addition, the wavelength selective filter 70(B) is disposed on the intersecting point of the course of the reflected light made incident from the first fiber collimator 101 and reflected by the wavelength selective filter 70(A) for demultiplexing, and the extension of the axial line of the third and fourth V-grooves 63 and 64, whereby the reflected light from the wavelength selective filter 70(A) for demultiplexing is further reflected by its own surface and the transmitted light made incident and transmitted from its own backside is multiplexed with the reflected light on the surface. Note that the wavelength selective filters 70(A, B) and the optical path correcting board 80 are fixed on the optical element disposal face 51 secured in the center of the substrate 50.

The wavelength selective filter 70(B) for multiplexing is fixed after angle adjustment, so that the reflected light made incident from the first fiber collimator 101, then reflected by the wavelength selective filter 70(A) for demultiplexing, and further reflected from the surface of the wavelength selective filter 70(B) for multiplexing is made incident to the third fiber collimator 103 on the third V-groove 63. By disposing the wavelength selective filter 70(B) for multiplexing, the fourth fiber collimator 104 is positioned on the backside of the wavelength selective filter 70(B) for multiplexing, whereby the light of a wavelength capable of transmitting through the backside of the wavelength selective filter 70(B) for multiplexing is made incident thereto. In addition, the optical path correcting board 80 that corrects the optical path deviation due to the wavelength selective filter 70(B) is disposed at an angle symmetrical with the wavelength selective filter 70(B), between the fourth fiber collimator 104 and the wavelength selective filter 70(B) for multiplexing.

Note that the constitution of each of the fiber collimators 101 to 104, the wavelength selective filter 70, and the constitution of the optical path correcting board 80 are almost same as that of the optical module according to the embodiment previously explained, except for a dimensional element, and therefore an explanation here is omitted.

When this optical module D1 is used as the optical wavelength demultiplex/multiplexing device, the first fiber collimator 101 is used as the input port (In) that receives the wavelength multiplex light from the external light transmission path 1001 for input, the third fiber collimator 103 on the lowermost stream side is used as the output port (Out) that emits the wavelength multiplex light to the external light transmission path 1003 for output, the second fiber collimator 102 is used as the branching port (Drop) that extracts the branched light to the light transmission path 1002 for branching, and the fourth fiber collimator 104 is used as the insertion port (Add) that introduces the insert light from the transmission paths 1004 and 1006 for insertion.

Thus, the optical signal of a particular wavelength λ1 out of the wavelength multiplex signals made incident from the input port (the first fiber collimator 101) transmits through the wavelength selective filter 70(A) for demultiplexing, and is extracted outside from the branching port (the second fiber collimator 102). Also, the light of the wavelength other than the particular wavelength is sequentially reflected by the wavelength selective filter 70(A) for demultiplexing and the wavelength selective filter 70(B) for multiplexing and is extracted outside from the output port (the third fiber collimator 103). At this time, when the signal light of the particular wavelength λ1 is inserted from the insertion port (the fourth fiber collimator 104), the signal light transmits from the backside to the front side of the wavelength selective filter 70(B) for multiplexing, then is multiplexed with the light of the wavelength other than the particular wavelength reflected from the front surface, and is extracted outside from the output port (the third fiber collimator 103).

Here, when the signal extracted from the branching port and the signal inserted from the insertion port are the signals of the same wavelengths, the optical wavelength multiplexing and demultiplexing device for 1ch is obtained by using the wavelength selective filter of the same characteristics as the wavelength selective filter 70(A) for demultiplexing and as the wavelength selective filter 70(B) for multiplexing. Also, when the signal extracted from the branching port and the signal inserted from the insertion port are the signals of different wavelengths, the wavelength selective filter of different characteristics may be used, such as using the wavelength selective filter capable of transmitting through the wavelength of the signal extracted from the branching port as the wavelength selective filter 70(A) for demultiplexing, and the wavelength selective filter capable of transmitting the wavelength of the signal inserted from the insertion port as the wavelength selective filter 70(B) for multiplexing.

Accordingly, the wavelength multiplexing function can be exhibited while exhibiting the wavelength demultiplexing function. Further, as the collimator, by adopting the fiber collimators 101 to 104 with coreless fiber, the low loss 1ch-type optical wavelength multiplexer/demultiplexer can be provided. In addition, each constituent component is fixed on the common substrate 50, and the optical space transmission is allowed to be performed between components, thus making it possible to eliminate a useless component without using it, the cost of the optical module can be reduced, and a small-sized optical module with a necessary minimum volume is realized. Further, all of the V-grooves 61 to 64 are formed in parallel, and further facing V-grooves 61 and 62, V-grooves 63 and 64 are respectively formed on the same axial line, thus facilitating the processing and assembly.

### Regarding the Optical Module D2 (Embodiment 9)

Next, the multiplexing/demultiplexing device for 2ch or more will be explained. Here, the optical module D2 for 2ch as shown in FIG. 16 is taken as an example, and a general optical module for 2ch or more and its constitution will be explained.

The optical module D2 for 2ch of D-series is provided with the wavelength selective filters 71 and 72 on the substrate 50, having the demultiplexing function of transmitting only the light of a particular wavelength out of the incident lights and reflecting the light of other wavelength, and the multiplexing function of multiplexing the transmitted light of a particular wavelength made incident and transmitted from the backside and the reflected light of other wavelength made incident to and reflected by the front surface. Here, two of the wavelength selective filters 71 and 72 having the same characteristics are set as one set and two sets of them is prepared for 2ch, and in a case of channels more than 2ch, sets of these ch-channels may be prepared. Such wavelength selective filters 71 and 72 are disposed, so that the reflected lights reflected by the wavelength selective filters 71 and 72 are made incident thereto sequentially from the lower stream side to the upstreamside side in the traveling direction of lights and two wavelength selective filters 71 and 72 of each set are continuous.

In addition, when the signal extracted from the branching port and the signal inserted from the insertion port have different wavelengths, as the wavelength selective filter 71 for demultiplexing, the wavelength selective filter capable of transmitting the signal of the wave length extracted from the branching port is used, and as the wavelength selective filter 72 for multiplexing, the wavelength selective filter capable of transmitting the signal of the wavelength inserted from the insertion port is used, thus the wavelength selective filter of different characteristics may be used.

In the two wavelength selective filters 71 and 72 of each set, the wavelength selective filters 71(A) and 72(A) on the upstream side is filters for demultiplexing, and the wavelength selective filters 71(B) and 72(B) of each set on the lower stream side is filters for multiplexing. Then, the fiber collimators 101 to 106 are respectively disposed:
(a) on the light path of the incident light to the wavelength selective filter 71(A) for demultiplexing on the uppermost stream side;
(b) on the light path of the transmitted light transmitted through the wavelength selective filters 71(A) and 72(A) for demultiplexing of each set on the upstream side;
(c) on the light path of the incident light made incident to the backside of the wavelength selective filters 71(B) and 72(B) for multiplexing of each set on the lower stream side; and
(d) on the light path of the reflected light of the wavelength selective filter 72(B) for multiplexing on the lowermost stream side.

Each of the fiber collimators 101 to 106 have completely the same constitution as that described before, and therefore explanation therefore is omitted here.

In these fiber collimators 101 to 106, the aforementioned (b) the second and third fiber collimators 102 and 103 positioned on the light path of the transmitted light of the wavelength selective filters 71(A) and 72(A) for demultiplexing of each set on the upstream side, the aforementioned (d) the fifth fiber collimator 105 positioned on the light path of the reflected light reflected by the wavelength selective filter 72(B) for multiplexing on the lowermost stream side, the aforementioned (a) the first fiber collimator 101 positioned on the light path of the incident light made incident to the wavelength selective filter 71(A) for demultiplexing on the uppermost stream side, and the aforementioned (c) the fourth and fifth fiber collimators 104 and 106 positioned on the light path of the incident light made incident to the backside of the wavelength selective filters 71(B) and 72(B) for multiplexing of each set on the lower stream side, are disposed on the collimator disposal faces 53 and 52 provided on one side and the other side of one substrate 50, so as to be faced with each other, with disposal space of the optical element (optical element disposal face 51) including the wavelength selective filters 81 and 82 between the one side and the other side of the substrate 50. In addition, each of the fiber collimators 101 to 106 are positioned so as to be disposed in the first to sixth V-grooves 61 to 66 formed on each collimator disposal face 52, 53 of the substrate 50.

These V-grooves 61 to 66 are formed in parallel, and out of them, the first V-groove 61 and the second V-groove 62 are positioned on the same line, the third V-groove 63 and the fourth V-groove 64 are positioned on the same axial line, and the fifth V-groove 65 and the sixth V-groove 66 are positioned on the same axial line. Then, the optical path correcting boards 81 and 82 are disposed on the light path between fiber collimators which are faced with each other because they are disposed respectively in the V-grooves positioned on the same axial line.

Each optical path correcting boards 81 and 82 functions to correct the optical path deviation caused by inserting the wavelength selective filters 71 and 72, and they are disposed on the light path of the transmitted light transmitted through the wavelength selective filters 71(A) and 72(A) for demultiplexing of each set on the upstream side, and on the light path of the incident light made incident to the backside of the wavelength selective filters 71(B) and 72(B) for multiplexing of each set on the lower stream side.

Next, explanation is given to a case of using the optical module of D-series thus constituted, with the optical module D2 for 2ch taken as an example.

When this optical module D2 is used as the wavelength optical multiplexing/demultiplexing device for 2ch, the fiber collimator 101 on the uppermost stream side is used as the input port (In) that receives the wavelength multiplex light from the external light transmission path 1001 for input, the fiber collimator 105 on the lowermost stream side is used as the output port (Out) that outputs the wavelength multiplex light to the external light transmission path 1005 for output, and out of other fiber collimators, the second fiber collimator 102 and the third fiber collimator 103 are used as the branching port (Drop) that extracts the branching light to the light transmission path 1002 for branching, and the fourth fiber collimator 104 and the sixth fiber collimator 106 are used as the insertion port (Add) that introduces the insertion light from the light transmission paths 1004 and 1006 for insertion.

In this way, while exhibiting the wavelength demultiplexing function of sequentially demultiplexing the wavelength multiplex signal made incident from the input port (the first fiber collimator 101) toward the branching port (the second and third fiber collimators 102 and 103), the wavelength multiplexing function of sequentially multiplexing the input signal from the insertion port (the fourth and sixth fiber collimators 104 and 106) can be exhibited. Namely, while sequentially extracting the lights of the wavelengths λ1 and λ2 selected by each wavelength selective filter 71(A) and 71(B) from each branching port (the second and third fiber collimators 102 and 103), the signals of the wavelengths λ1 and λ2 are newly inserted/multiplexed from the insertion port (the fourth and sixth fiber collimators 104 and 106), and a final signal can be extracted from the output port (the fifth fiber collimator 105).

Accordingly, by adopting the fiber collimators 101 to 106 with coreless fiber as the collimator, the low loss multi-ch type optical wavelength multiplexer/demultiplexer can be provided. In addition, each constituent component is fixed on a common substrate 50, the light is allowed to perform space transmission between components. Therefore, without using a useless component, and with a minimum necessary volume, the optical module can be miniaturized at a low cost. Further, since all of the V-grooves 61 to 66 are formed in parallel, and further the facing V-grooves 61, 62, 63, 65, and 66 are formed on the same axial line, thus facilitating the processing and assembly. Therefore, with simply the assembly by easy positioning, the low insertion loss optical demultiplexing function can be obtained, while satisfying sufficient reflection attenuation.

Next, a manufacturing method of the optical modules D1 and D2 of D-series is explained. Note that the optical module D1 for 1ch can be prepared in an intermediate step of the manufacturing method of the optical module D2 for 2ch, and therefore on behalf of the optical module D1 for 1ch, only the manufacturing method of the optical module D2 for 2ch is explained.

<Manufacturing Method of the Optical Module D2>

The optical module D2 as shown in FIG. 16 can be manufactured as follows.

First, the substrate 50 formed with six first to sixth V-grooves 61 to 66 is prepared. Here, the first, fourth, and sixth V-grooves 61, 64, and 66 are formed on the collimator disposal face 52 of the one side of the substrate 50 in this order, and the second, third, and fifth V-grooves 62, 63, and 65 are formed on the collimator disposal face 53 of the other side of the substrate 50. These V-grooves 61 to 66 are formed so as to be aligned in parallel on the same plane. Here, the first V-groove 61 and the second V-groove 62, the fourth V-groove 64 and the third V-groove 63, and the sixth V-groove 66 and the fifth V-groove 65 are disposed on the same axial line. In addition the V-grooves aligned on the same side are disposed at equal pitches.

When the substrate 50 is prepared, next, in the same way as the case of the optical module A (see FIG. 1), the optical fiber terminal 110 and the collimator lens 120 are respectively disposed in the first and second V-grooves 61 and 62, and positional adjustment is applied thereto, and the first and second fiber collimators 101 and 102 are created. Subsequently, the first wavelength selective filter 71(A) for demultiplexing is disposed at a previously designed angle, on the light path between the first fiber collimator 101 and the second fiber collimator 102.

Next, the optical fiber terminal 110 and the collimator lens 120 are disposed and the third fiber collimator 103 is temporarily assembled, in the third V-groove 63 adjacent to the second V-groove 62. In addition, the first wavelength selective filter 71(B) for multiplexing is disposed on the intersecting point of the optical axis of the reflected light reflected by the first wavelength selective filter 71(A) for demultiplexing and the extension of the axial line of the third and fourth V-grooves 63 and 64, so that the lights inputted from the first fiber collimator 101 and successively reflected by the first wavelength selective filter 71(A) for demultiplexing and the first wavelength selective filter 71(B) for multiplexing is made incident to the third fiber collimator 103.

Next, the light of the wavelength reflected by the first wavelength selective filters 71(A) and 71(B) is inputted to the first fiber collimator 101, and while confirming the amount of the light coupled to the optical fiber terminal 110 of the third fiber collimator 103 through the wavelength selective filters 71(A) and 71(B), the position and direction of the first wavelength selective filter 71(B) for multiplexing and the distance between the optical fiber terminal 110 and the collimator lens 120 constituting the third fiber collimator 103 are determined and fixed.

Next, the second wavelength selective filter 72(A) for demultiplexing is disposed at a previously designed angle, between the first wavelength selective filter 71(B) for multiplexing and the third fiber collimator 103. In addition, the optical fiber terminal 110 and the collimator lens 120 are disposed and the fifth fiber collimator 105 is temporarily assembled in the fifth V-groove 65 adjacent to the third V-groove 63. Further, the second wavelength selective filter 72(B) for multiplexing is disposed on the intersecting point of the optical axis of the reflected light reflected by the second wavelength selective filter 72(A) for demultiplexing and the extension of the axial line of the fifth and sixth V-grooves 65 and 66, so that the lights inputted from the first fiber collimator 101 and successively reflected by the first wavelength selective filter 71(A), the first wavelength selective filter 71(B) for multiplexing, the wavelength selective filter 72(A) for demultiplexing, and the second wavelength selective filter 72(B) for multiplexing is made incident to the fifth fiber collimator 105.

Next, the light of the wavelength reflected by the first wavelength selective filters 71(A) and 71(B), and the second wavelength selective filters 72(A) and 72(B) is inputted to the first fiber collimator 101, and while confirming the amount of the light sequentially reflected by the wavelength selective filters 71(A), 71(B), 72(A), and 72(B) and is coupled to the optical fiber terminal 110 of the third fiber collimator 103, the position and direction of the second wavelength selective filter 72(B) for multiplexing and the distance between the optical fiber terminal 110 and the collimator lens 120 constituting the fifth fiber collimator 105 are determined and fixed.

Next, the optical path correcting board 81 that corrects the optical path deviation due to the first wavelength selective filter 71 is disposed at an angle symmetrical with the first wavelength selective filter 71(A) for demultiplexing, between the first wavelength selective filter 71(A) for demultiplexing and the second fiber collimator 102. At this time, the light of the wavelength transmitted through the first wavelength selective filter 71 is inputted to the first fiber collimator 101, and an attachment angle of the optical path correcting board 81 is slightly adjusted and fixed, by the amount of the light outputted from the optical fiber terminal 110 of the second fiber collimator 102.

Next, the optical path correcting board 82 that corrects the optical path deviation due to the second wavelength selective filter 72 is disposed at an angle symmetrical with the second wavelength selective filter 72(A), between the second wavelength selective filter 72(A) for demultiplexing and the third fiber collimator 103. At this time, the light of the wavelength reflected by the first wavelength selective filter 71 and transmitted through the second wavelength selective filter the second wavelength selective filter 72 is inputted to the first fiber collimator 101, and the attachment angle of the optical path correcting board 82 is slightly adjusted and fixed, by the amount of the light outputted from the optical fiber terminal 110 of the third fiber collimator 103.

Next, the optical fiber terminal 110 and the collimator lens 120 are disposed and the fourth fiber collimator 104 is temporarily assembled, in the fourth V-groove adjacent to the first V-groove 61. In addition, the optical path correcting board 81 that corrects the optical path deviation due to the first wavelength selective filter 71 is disposed at an angle symmetrical with the first wavelength selective filter 71(B), between the fourth fiber collimator 104 and the first wavelength selective filter 71(B), and either one of the optical fiber terminal 110 or the collimator lens 120 is fixed to the fourth V-groove 64.

Next, the light of the wavelength capable of transmitting through the first wavelength selective filter 71 is inputted to the optical fiber terminal 110 of the fourth fiber collimator 104, and while confirming the amount of the light coupled to the optical fiber terminal 110 of the third fiber collimator 103, the distance between the optical fiber terminal 110 of the fourth fiber collimator 104 and the collimator lens 120, and the angle of the optical path correcting board 81 are slightly adjusted and fixed.

Next, the optical fiber terminal 110 and the collimator lens 120 are disposed and the sixth fiber collimator 106 is temporarily assembled, in the sixth V-groove 66 adjacent to the fourth V-groove 64. In addition, the optical path correcting board 82 of the same characteristic as that of the second wavelength selective filter 72 is disposed at an angle symmetrical with the second wavelength selective filter 72(B) for multiplexing, and either one of the optical fiber terminal 110 or the collimator lens 120 is fixed to the sixth V-groove 66.

Next, the light of the wavelength capable of transmitting through the second wavelength selective filter 72 is inputted to the optical fiber terminal 110 of the sixth fiber collimator 106, and while confirming the amount of the light coupled to the optical fiber terminal 110 of the fifth fiber collimator 105, the distance between the optical fiber terminal 110 of the sixth fiber collimator 106 and the collimator lens 120 and the angle of the optical path correcting board 82 are slightly adjusted and fixed.

As described above, positions of all of the members are determined and fixed, thus completing the optical module D2 having a small-sized and low loss optical module D2 having the optical multiplexing/demultiplexing function and easy to be assembled. In this case, regarding the wavelength selective filters 71 and 72 being the optical element and the position and the adjustment of the angle of the optical path correcting boards 81 and 82, all of the V-grooves 61 to 66 are in the same plane and all of the optical axes of the collimated light in the V-grooves 61 to 66 do not move from this plane, and thus only by two-dimensional optical axis adjustment, the low loss optical coupling can be easily obtained.

Note that as described above, the case of manufacturing the optical module D2 for 2ch has been explained. However, in a case of multi-channels, the above steps may only to be repeated.

In addition, all dimensions and specifications of members of the above-described embodiments are not limited thereto, and an assembling method is not limited thereto.

Also, according to the aforementioned embodiments, the wavelength selective filter can be replaced with a filter having other functions, however, in all of the aforementioned embodiments, it may be so constructed that a gain equalizing filter or a filter for extracting only a part of the quantity of the incident lights is disposed in either one of the front of or behind or both of the front and behind the wavelength selective filter when one wavelength selective filter is used, and is disposed in either one of the front of the wavelength selective filter on the uppermost stream side or behind the wavelength selective filter on the lowermost stream side or in both of the front and behind the wavelength selective filters on the uppermost stream side and on the lowermost stream side when a plurality of wavelength selective filters are used, so that each filter exhibits each function.

As described above, according to the present invention, by fixing the fiber collimator with high straight traveling performance according to a guide of the common substrate (positioning groove), an optical alignment that has occupied a large part of the cost of the optical passive module heretofore can be significantly reduced, thus making it possible to reduce the cost. In addition, since the optical space transmission between components is allowed, the optical module can be miniaturized at a low cost, without using a useless component and with a minimum necessary volume.

### BRIEF DESCRIPTION OF THE DRAWINGS

FIG. 1 is a block diagram of an optical module A of a first embodiment of the present invention, (a) is a plan view, and (b) is a side view.

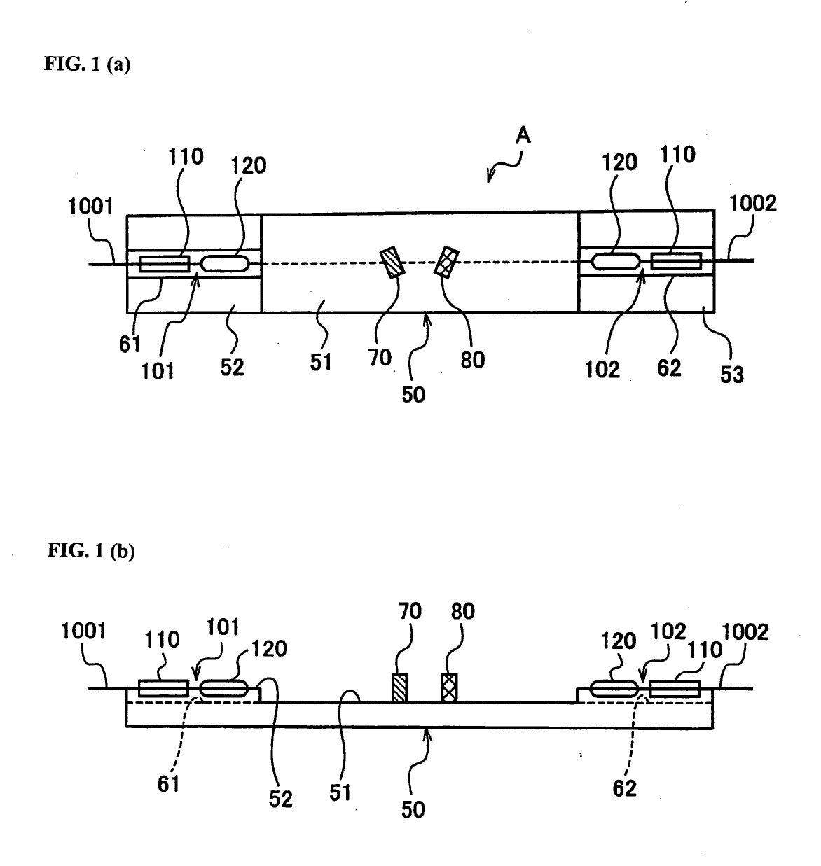

FIG. 2 is an expanded view showing a constitution of a fiber collimator used in the optical module A.

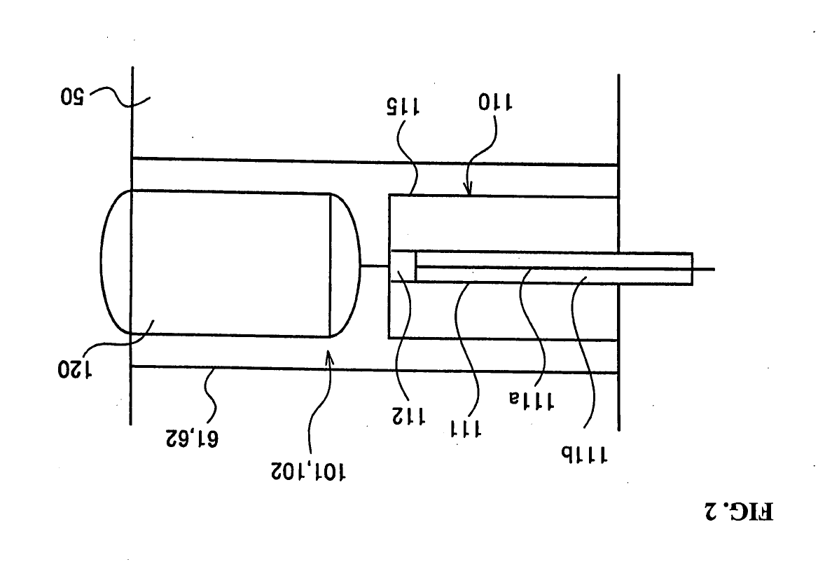

FIG. 3 is an expanded view showing a constitutional example of another fiber collimator.

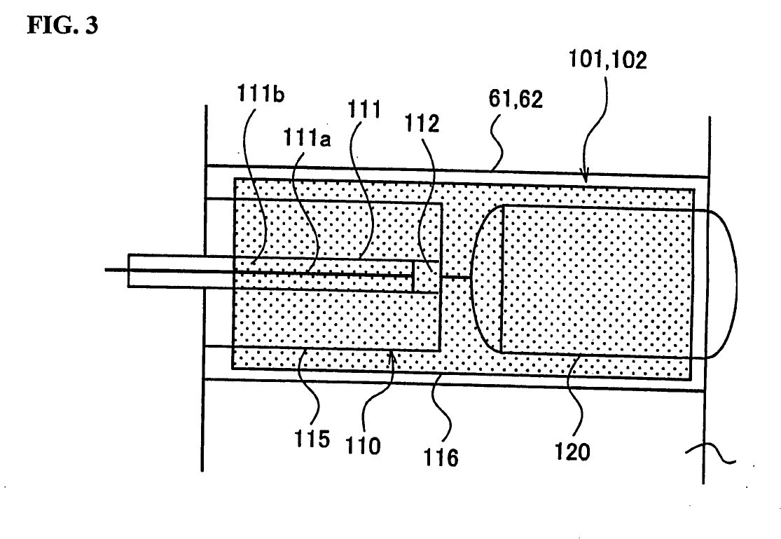

FIG. 4 is a block diagram of an optical module B1 of a second embodiment of the present invention, (a) is a plan view, and (b) is a side view.

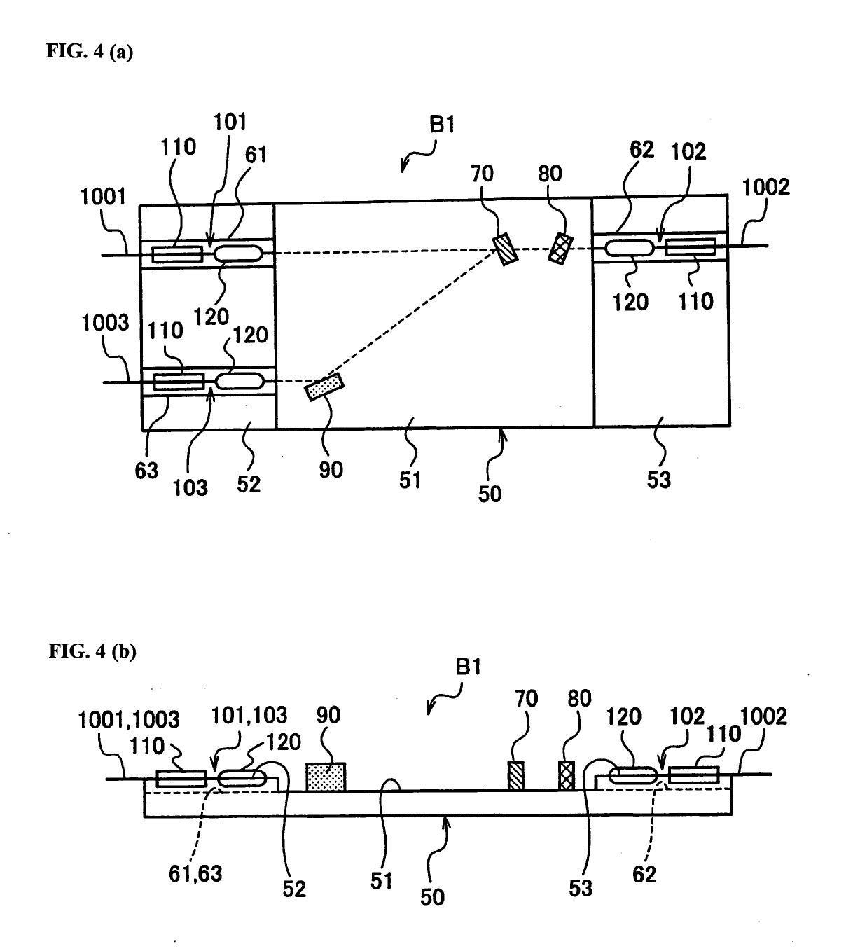

FIG. 5 is a view showing a use example of the optical module B1, (a) shows a case when the optical module B1 is used as an optical wavelength demultiplexing device, (b) shows a case when the optical module B1 is used as an optical wavelength multiplexing device.

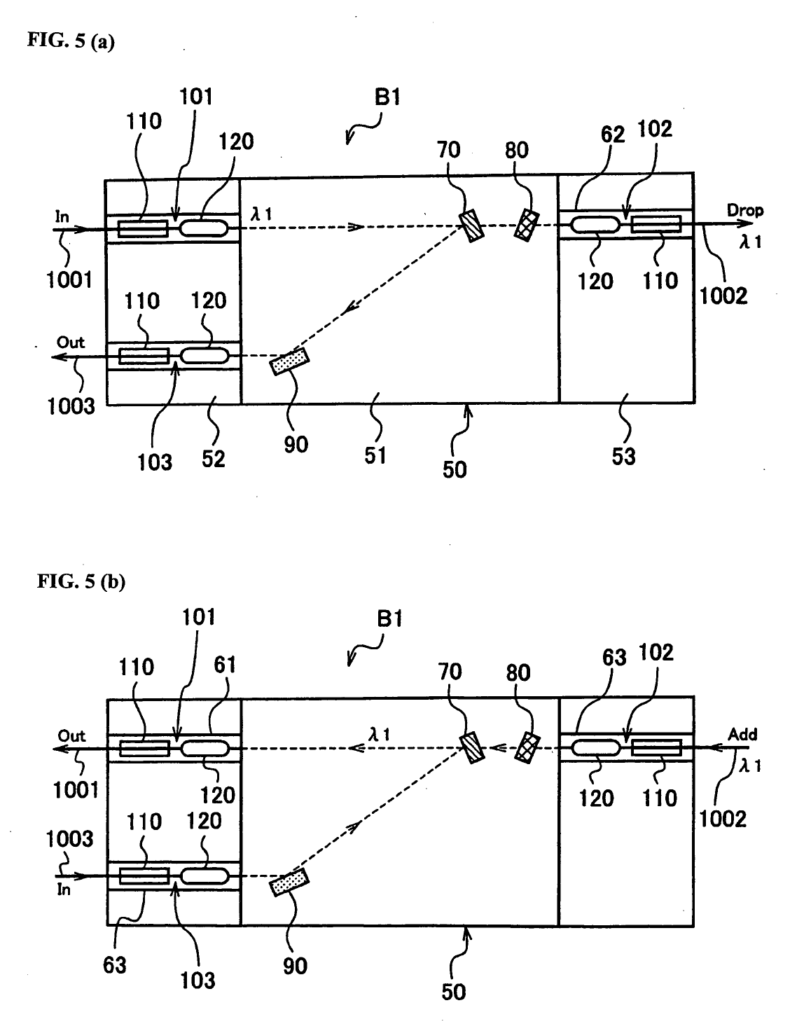

FIG. 6 is a block diagram of the optical module B2 of a third embodiment of the present invention, (a) is a plan view, and (b) is a side view.

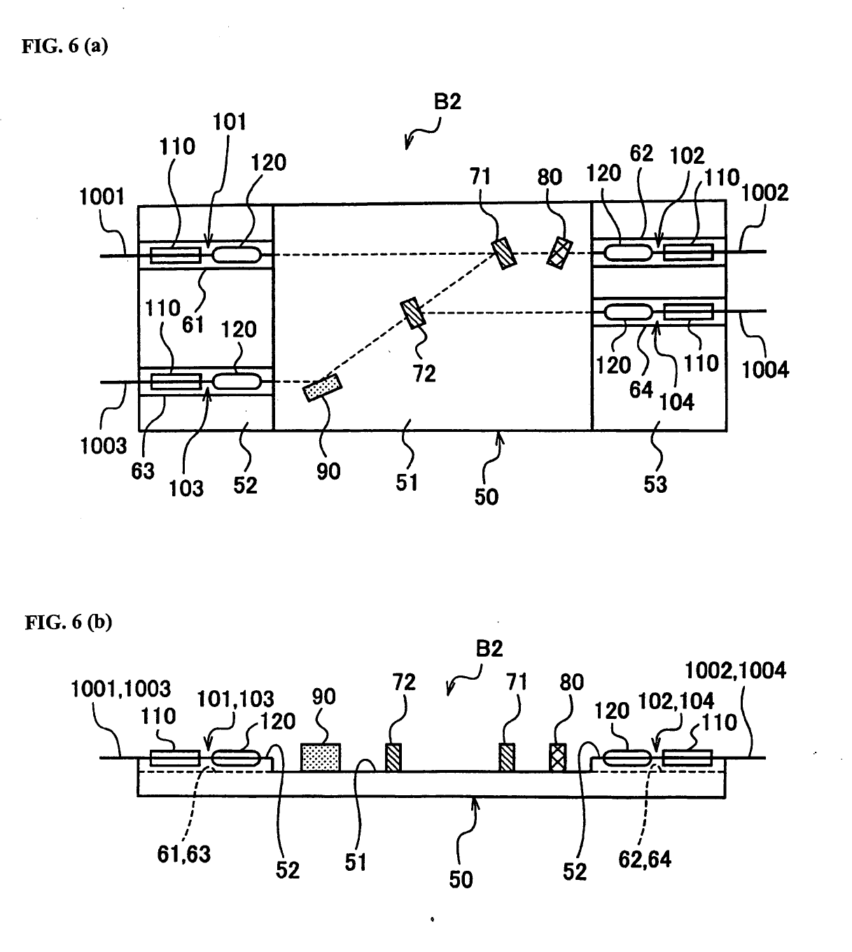

FIG. 7 shows a use example of the optical module B2, (a) shows a case when the optical module B2 is used as the optical wavelength demultiplexing device, and (b) shows a case when the optical module B2 is used as the optical wavelength multiplexing device.

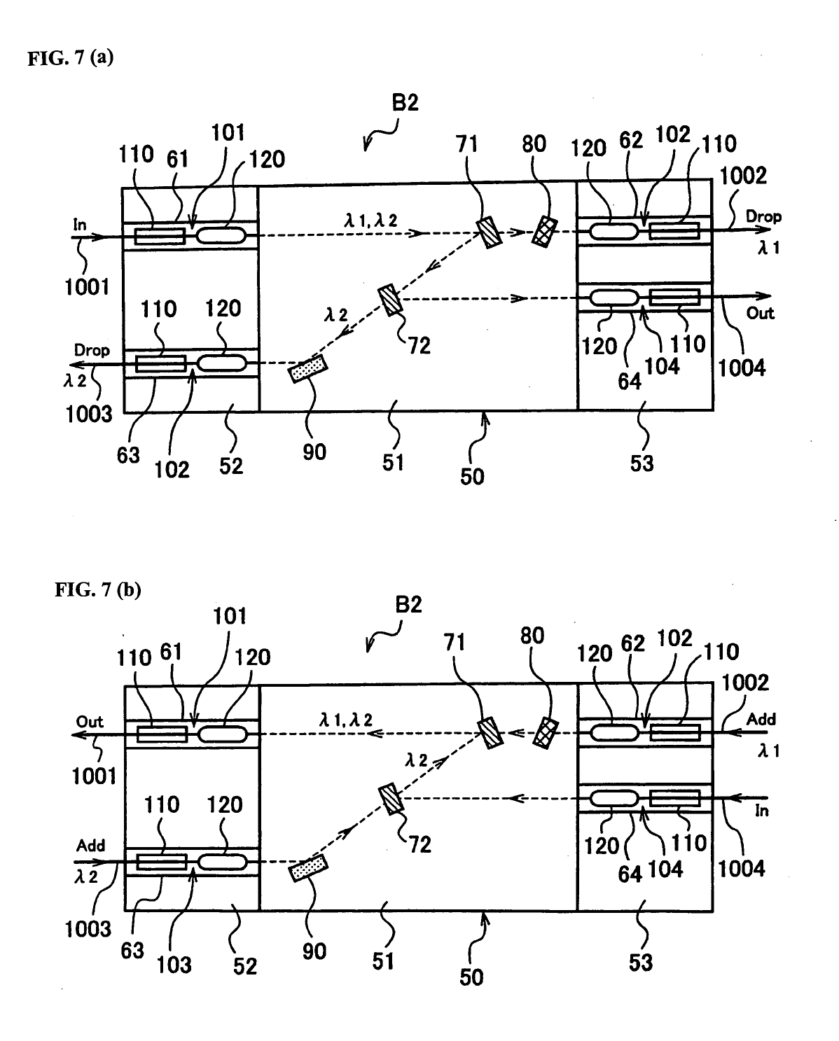

FIG. 8 is a block diagram of an optical module B3 of a fourth embodiment of the present invention, (a) is a plan view, and (b) is a side view.

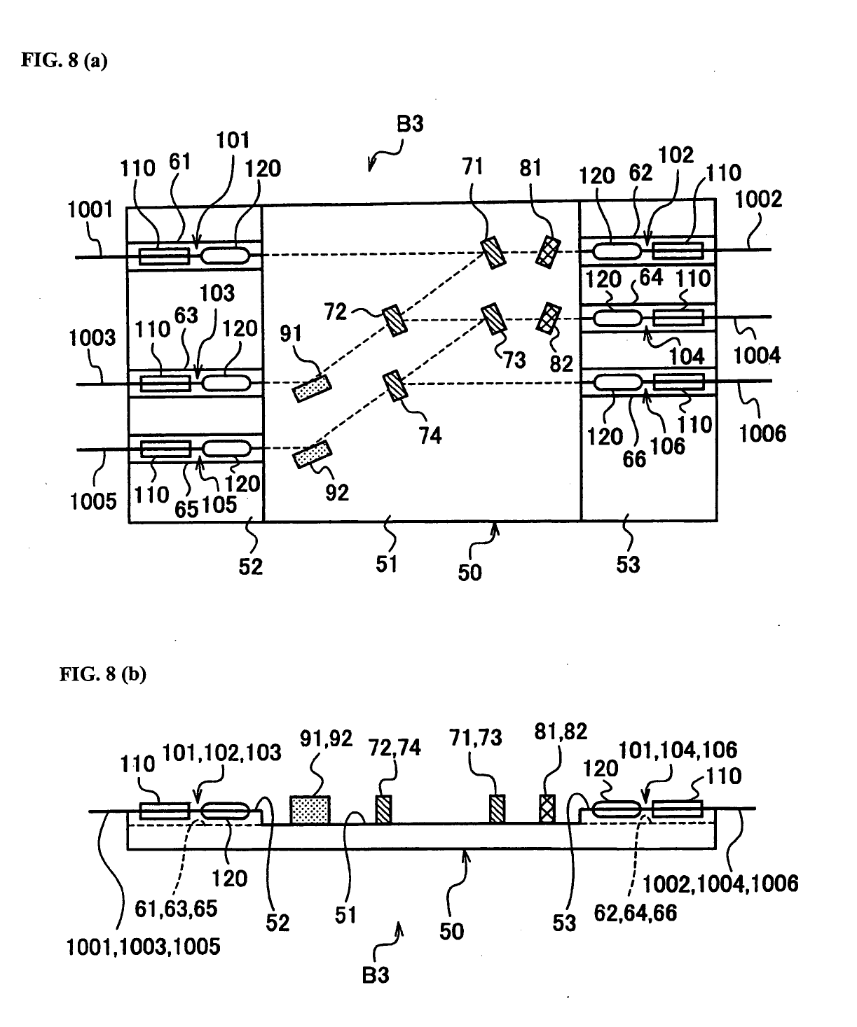

FIG. 9 shows a use example of the optical module B3, (a) shows a case when the optical module B3 is used as the optical wavelength demultiplexing device, (b) shows a case when the optical module B3 is used as the optical wavelength multiplexing device.

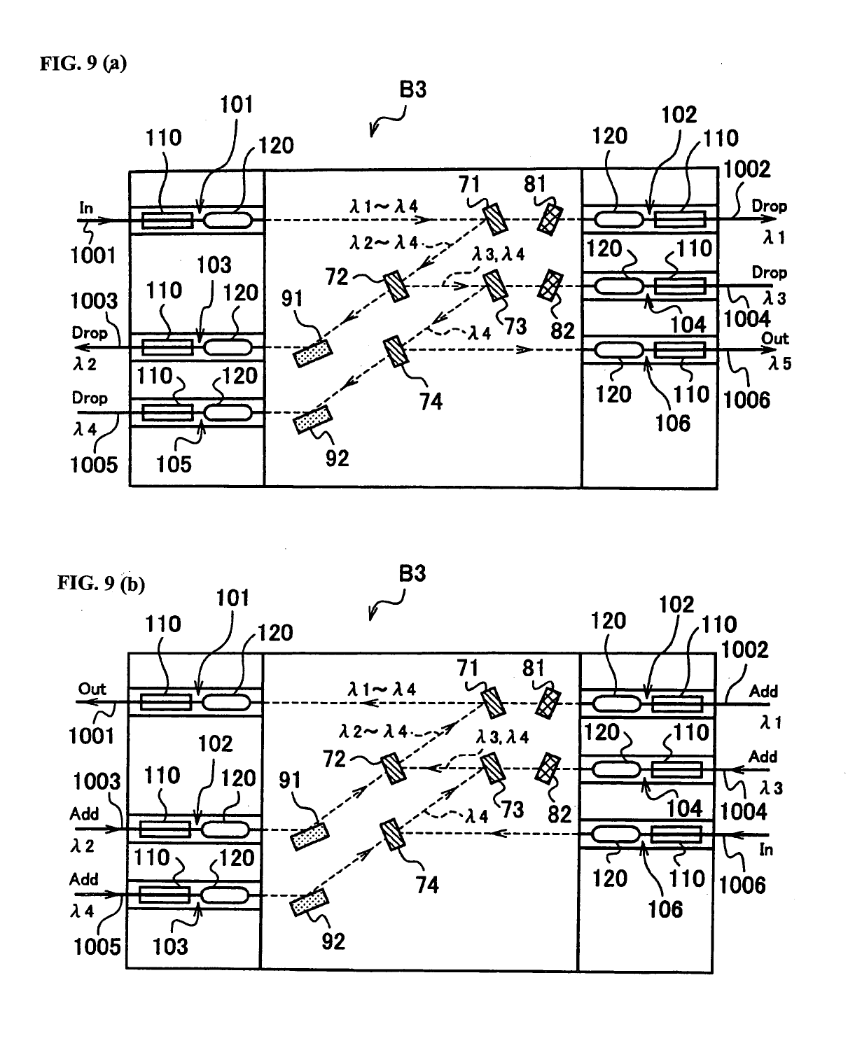

FIG. 10 is a block diagram of an optical module C1 of a fifth embodiment of the present invention, (a) is a plan view, and (b) is a side view.

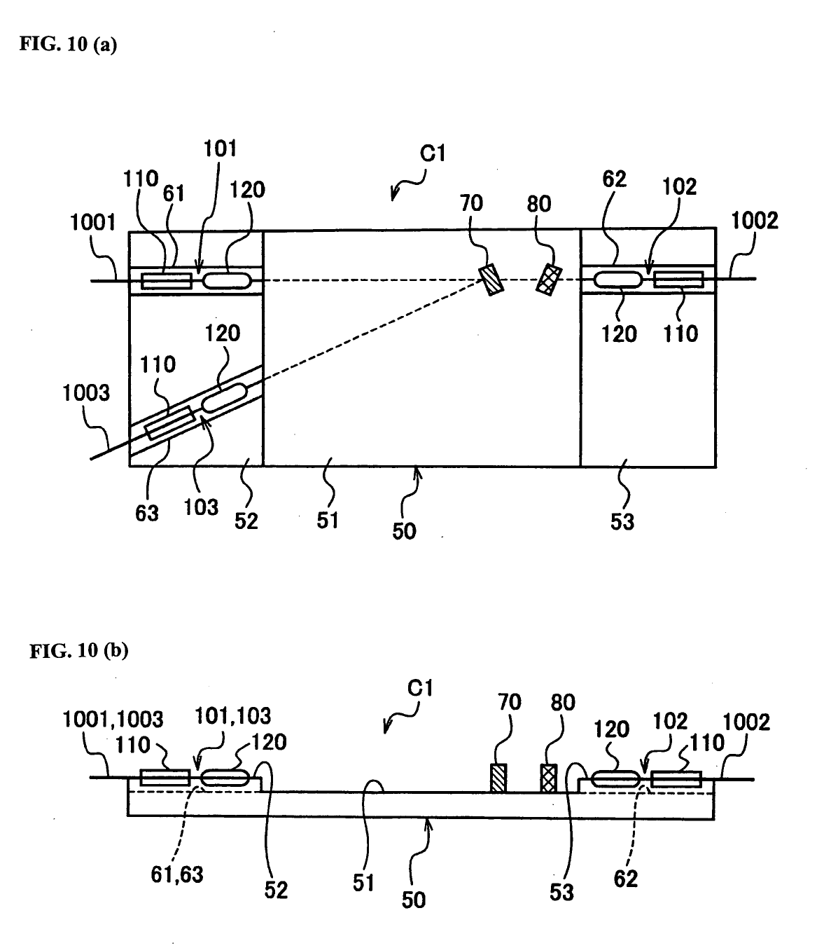

FIG. 11 is a block diagram of an optical module C2 of a sixth embodiment of the present invention, (a) is a plan view, and (b) is a side view.

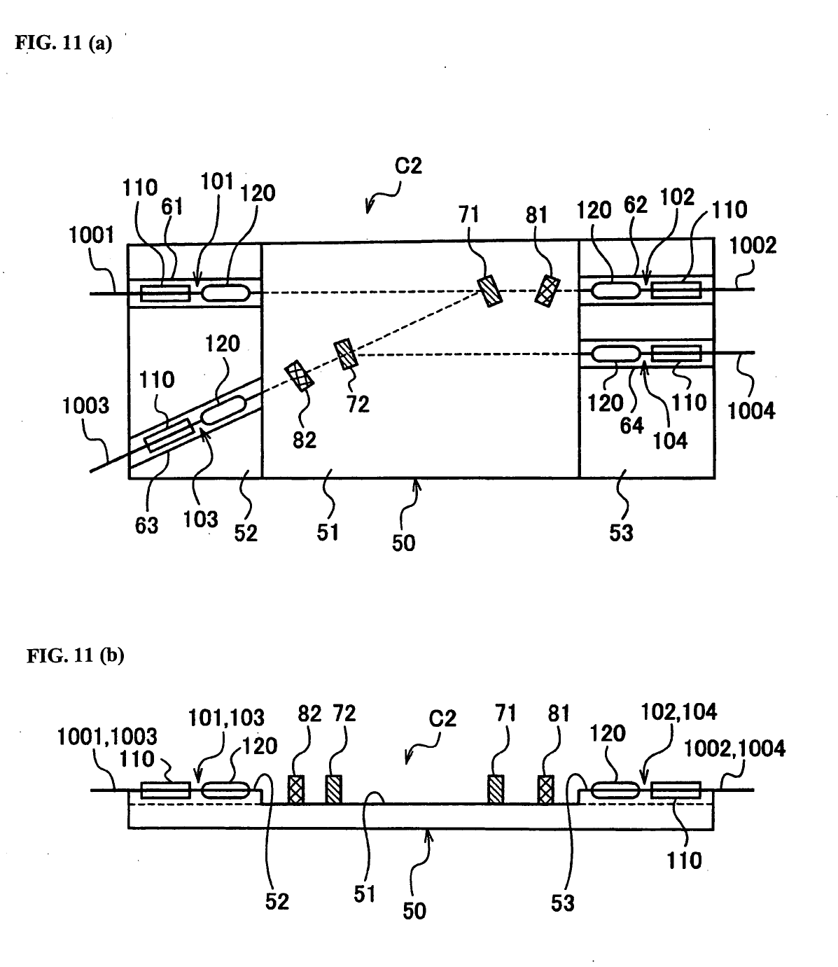

FIG. 12 is a block diagram of an optical module C3 of a seventh embodiment of the present invention, (a) is a plan view, and (b) is a side view.

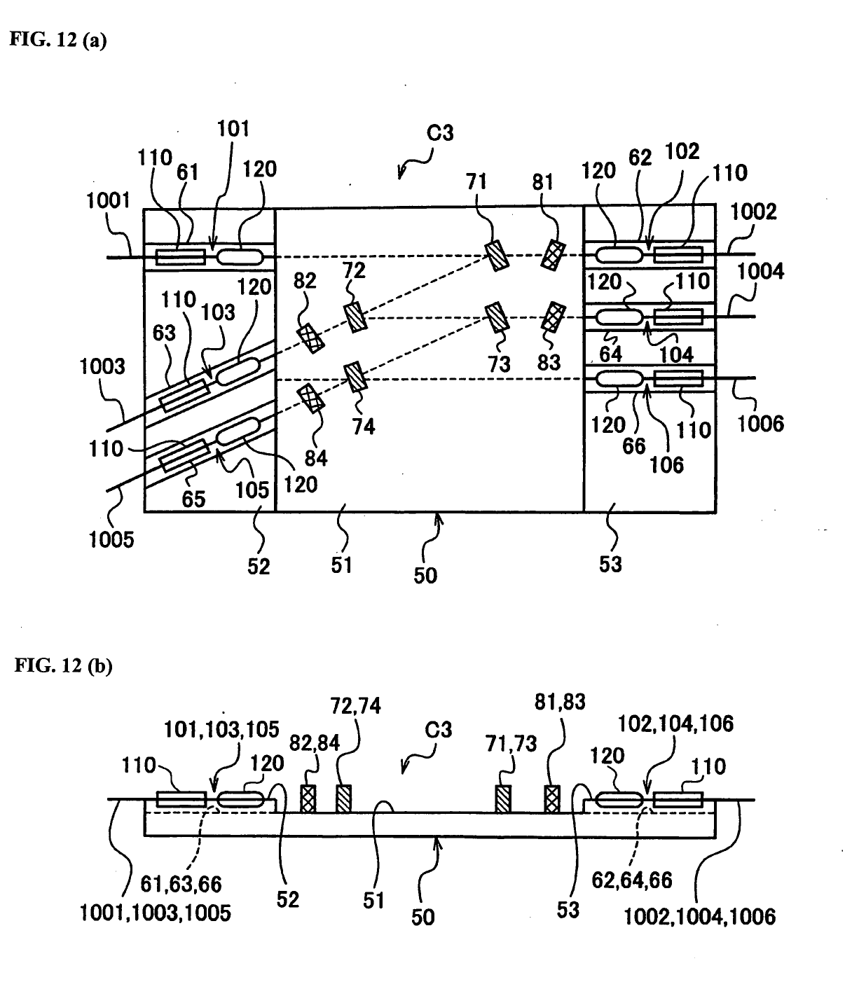

FIG. 13 is a block diagram of a case when an optical wavelength multiplexing and demultiplexing device for 1ch is constituted by pairing and combining the optical modules B1 of a second embodiment of the present invention.

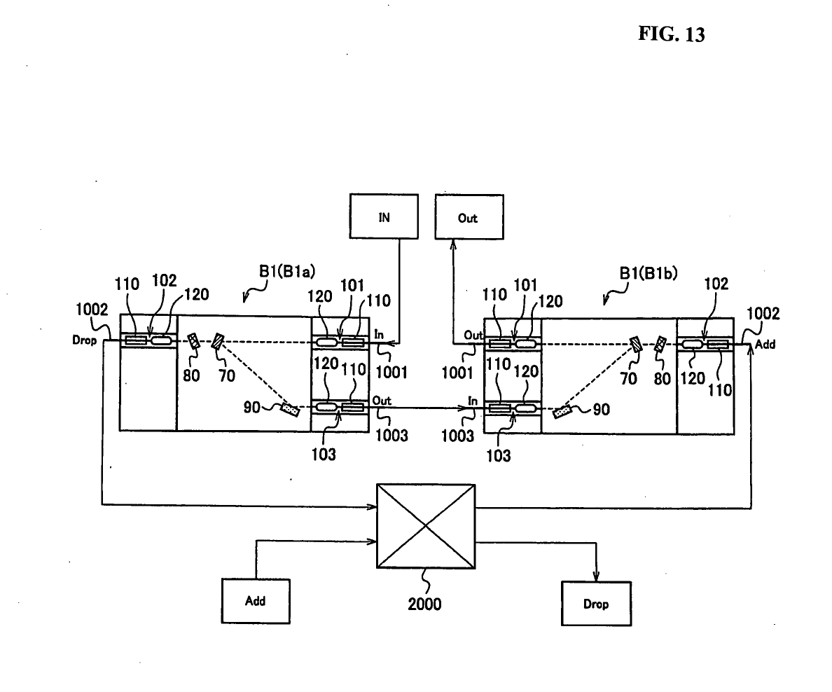

FIG. 14 is a block diagram of a case when the optical wavelength multiplexing and demultiplexing device for 4ch is constituted by pairing and combining the optical modules B3 of the fourth embodiment of the present invention.

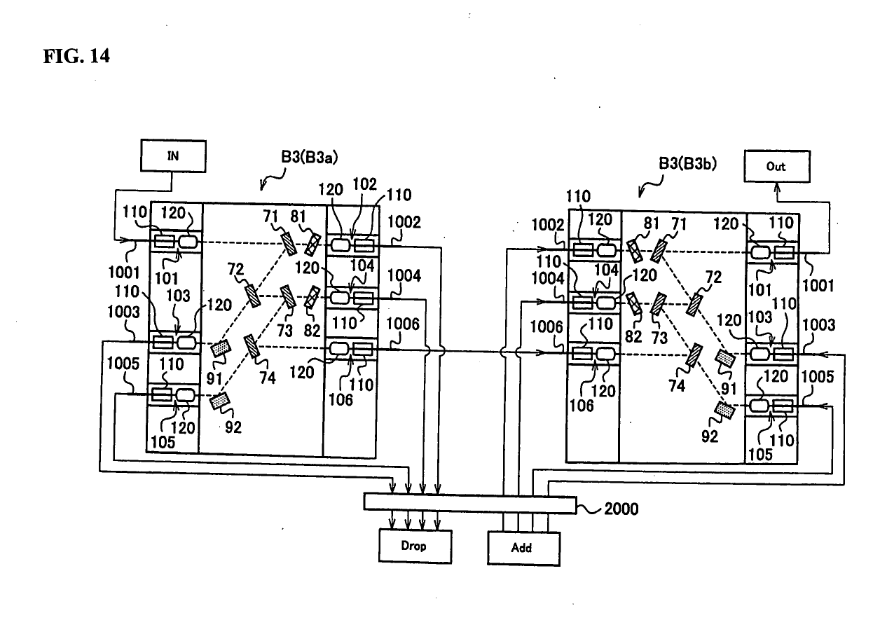

FIG. 15 is a block diagram of an optical module D1 of an eighth embodiment of the present invention, (a) is a plan view, and (b) is a side view.

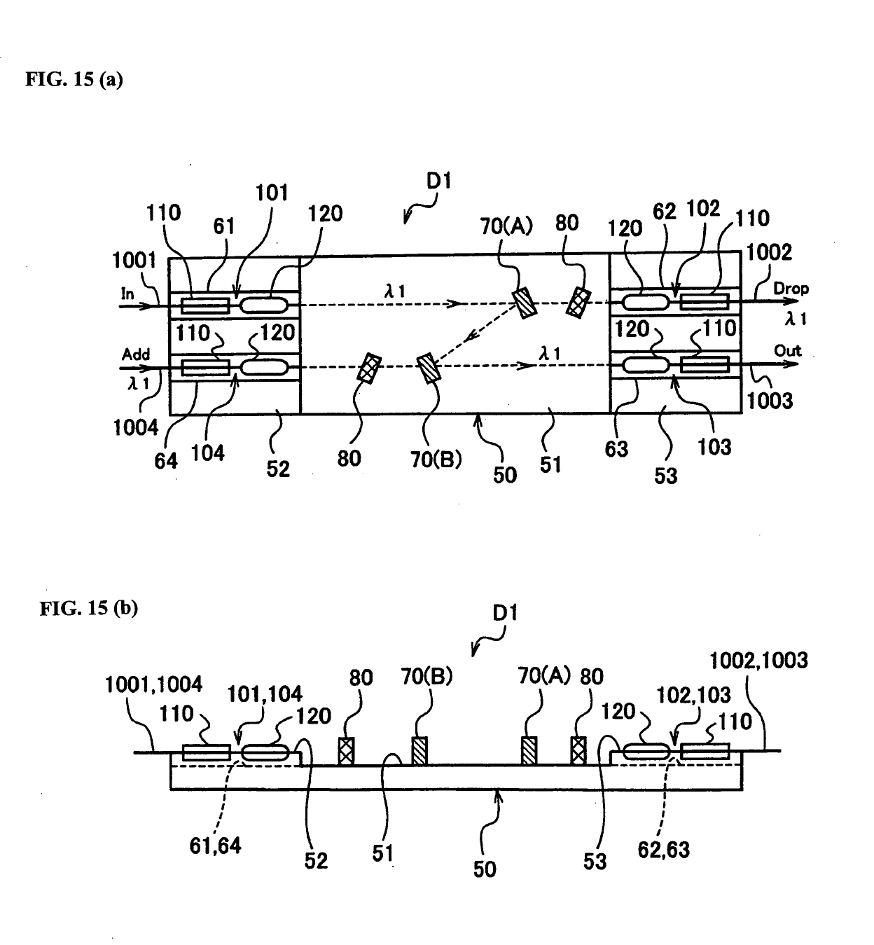

FIG. 16 is a block diagram of an optical module D2 of the eighth embodiment of the present invention, (a) is a plan view, and (b) is a side view.

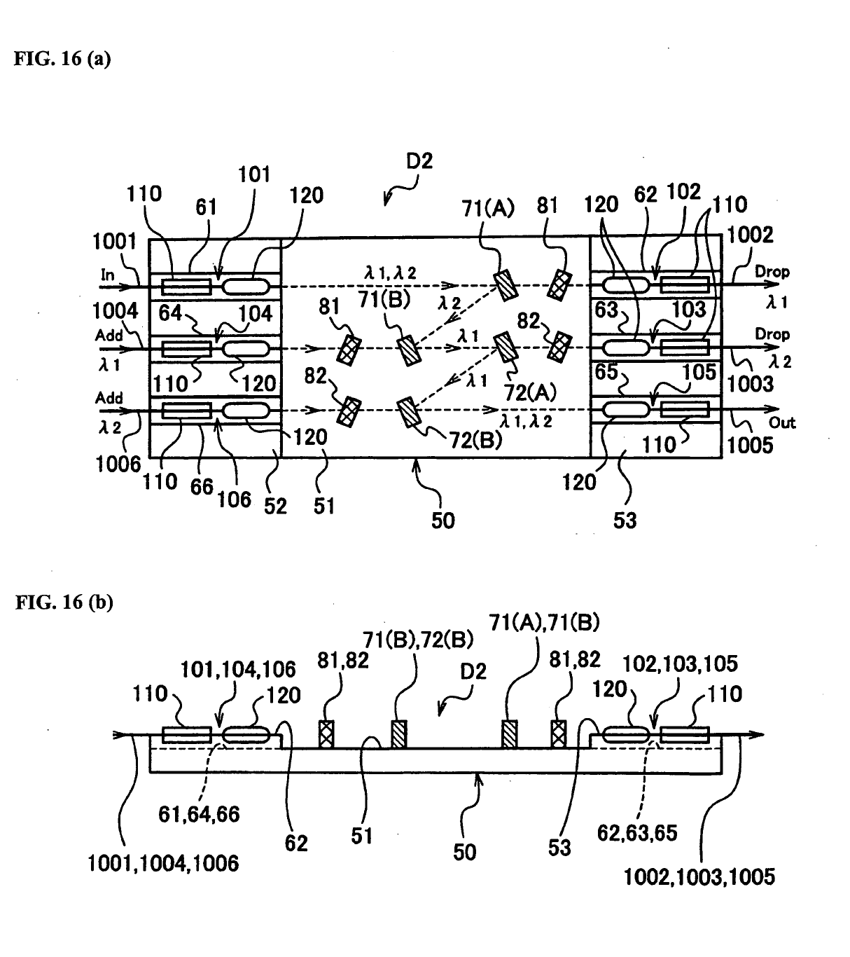

FIG. 17 is a schematic block diagram of a conventional optical add/drop device.

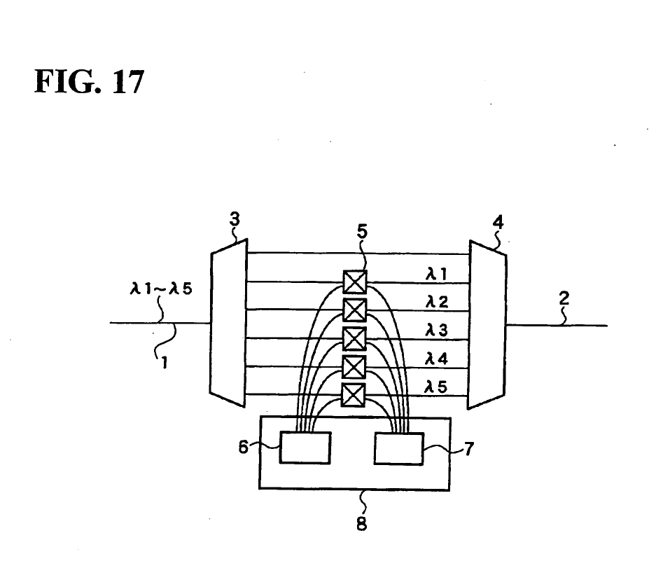

FIG. 18 is an explanatory view of an optical axis deviation of a collimator.

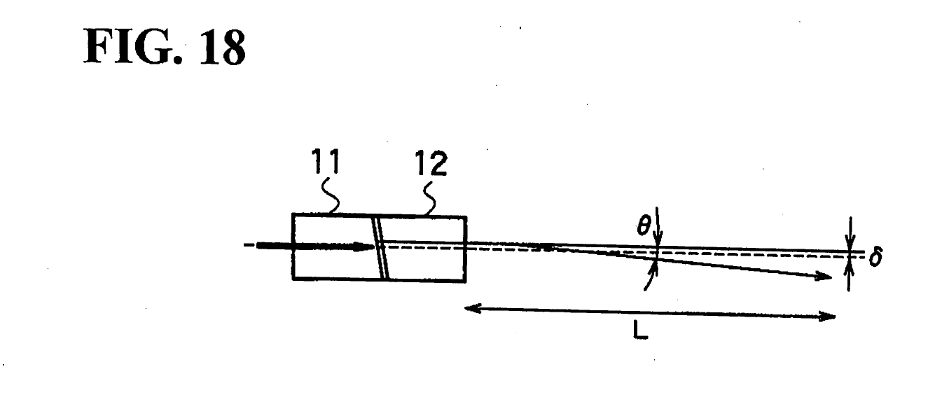

FIG. 19 is a view showing characteristics of the optical axis deviation of the collimator.

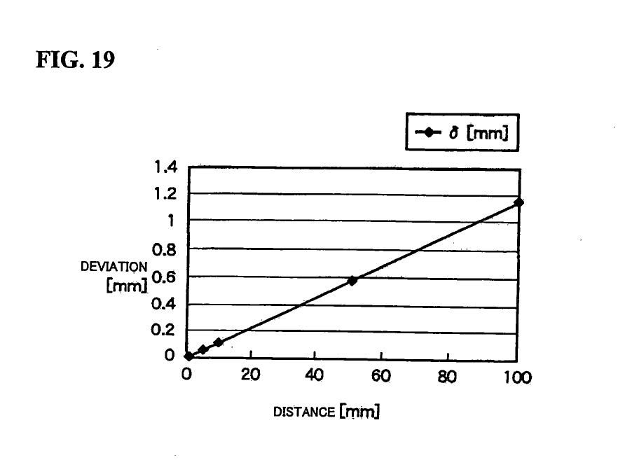

FIG. 20 is an explanatory view of the optical axis deviation of a wavelength selective filter.

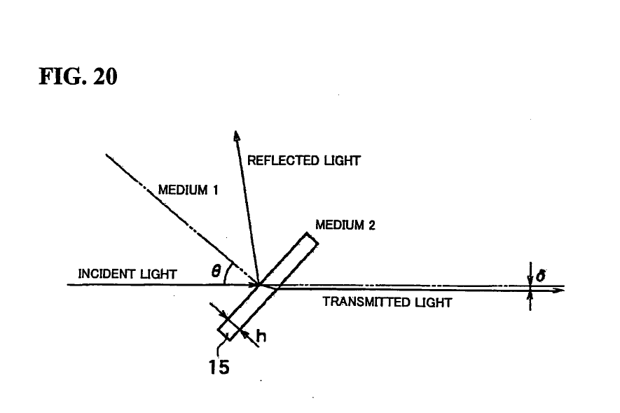

FIG. 21 is a view showing the characteristics of the optical axis deviation of the wavelength selective filter.

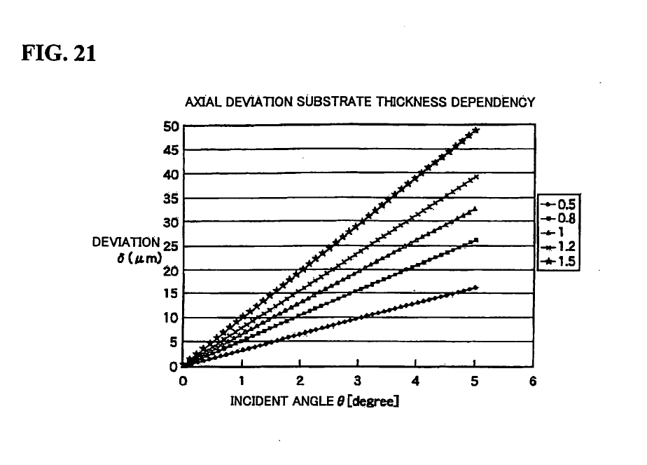

### DESCRIPTION OF SIGNS AND NUMERALS

A, B1, B2, B3, C1, C2, C3, D1, D2 Optical module
50 Substrate
51 Optical element disposal face (Optical element disposal space)
52 Collimator disposal face (collimator disposal space)
61 to 66 V-grooves (positioning grooves)
70, 71 to 74 Wavelength selective filter (optical element)
80, 81, 82 Optical path correcting board
90, 91, 92 Mirror (optical path correcting board)
101 to 106 Fiber collimator
110 Optical fiber terminal
111 Optical fiber
111a Core
111b Clad
120 Collimator lens

1. An optical module, wherein two sets of first and second fiber collimators are constituted in such a way that one end face of a coreless fiber, which consists of material having a homogeneous refractive index roughly identical to that of the core, is coupled to the end face of an optical fiber having the core of a center portion and a clad disposed on the outer circumference of the core, and a collimator lens is disposed on the other end face side of the coreless fiber on an optical axis of the optical fiber, and the fiber collimators thus constituted are disposed so as to face with each other in a first and second positioning grooves formed on one substrate so as to be positioned on the same axial line, and optical elements having a filter function are arranged between facing surfaces of the fiber collimators.

2. The optical module according to claim 1, wherein the fiber collimators are constituted in such a way that a terminal of the optical fiber having the coreless fiber coupled to its end face and the collimator lens are arranged in the positioning grooves.

3. The optical module according to claim 1, wherein the fiber collimators are constituted in such a way that the terminal of the optical fiber having the coreless fiber coupled to its end face and the collimator lens are disposed in glass tubes, as a single mode of optical component, and the glass tubes of the fiber collimators constituted as the single mode of optical component are disposed in the positioning grooves.

4. The optical module according to claim 1, comprising a wavelength selective filter having a demultiplexing function of allowing only the light of a particular wavelength out of the wavelength multiplex lights made incident to this filter from the first fiber collimator to transmit toward the second fiber collimator and reflect the light of other wavelength, and a multiplexing function of multiplexing toward the first fiber collimator transmitted light of a particular wavelength being made incident to and transmit through one side of this filter from the second fiber collimator, and reflected light of a particular wavelength made incident to and reflect from the other side, and
an optical path correcting board is provided between the wavelength selective filter and the second fiber collimator.

5. The optical module according to claim 4, wherein a third fiber collimator having the same constitution as that of the first and second fiber collimators is disposed in the course of the reflected light made incident from the first fiber collimator and is reflected by the wavelength selective filter, and this third fiber collimator is positioned in a third positioning groove formed on the same plane as the first and second positioning grooves on the substrate.

6. The optical module according to claim 5, wherein the third positioning groove is formed in parallel to the first and second positioning grooves, and an optical path correcting means is disposed between the third fiber collimator disposed in the third positioning groove and the wavelength selective filter, for coupling the reflected light reflected by the wavelength selective filter mutually between the first fiber collimator and the third fiber collimator.

7. The optical module according to either of claim 5, wherein an optical wavelength demultiplexing device demultiplexes a wavelength multiplex light by using the first fiber collimator as a collimator for input light that allows the wavelength multiplex light sent from an external light transmission path for input to be made incident to the wavelength selective filter as input light, using the second fiber collimator as a collimator for branch light for extracting outside the light of a particular wavelength made incident to and transmitted through the wavelength selective filter, and using the third fiber collimator as a collimator for output light for sending light of the wavelength excluding the particular wavelength made incident to and reflected by the wavelength selective filter to an external light transmission path for output.

8. The optical module according to either of claim 5, wherein the light wavelength multiplexing device is constituted by using the third fiber collimator as a collimator for input light for allowing the light of the wavelength excluding a particular wavelength sent from the external input light transmission path to be made incident to the surface of the wavelength selective filter as an input light, using the second fiber collimator as a collimator for insert light for allowing the light of the particular wavelength to be made incident to the backside of the wavelength selective filter as an insert light, and using the first fiber collimator as a collimator for output light for sending the multiplex light of the input light and the insert light to the external light transmission path for output, the input light being reflected by the wavelength selective filter and the insert light transmitting through the wavelength selective filter.

9. An optical module, comprising:
a plurality of wavelength selective filters, having a demultiplexing function of allowing only the light of a particular wavelength out of incident lights and reflecting the light of other wavelength, and a multiplexing function of multiplexing transmitted light of a particular wavelength made incident from one side and transmitted through this side and reflected light of other wavelength made incident from other side and reflected by this side, with the particular wavelengths differentiated,
wherein the plurality of selective filters are disposed so that the reflected light reflected by the filter is sequentially made incident from the upstream side to the downstream side in a traveling direction of the light,
collimators are disposed on a light path of incident light made incident to the wavelength selective filter on the uppermost stream side, on a light path of transmitted light that transmits through each wavelength selective filter, and on a light path of the reflected light reflected by the wavelength selective filter on the lowermost stream side, and
as each collimator, one end face of a coreless fiber, which consists of a material having a homogeneous refractive index roughly identical to that of the core, is coupled to an end face of the optical fiber having a core of a center portion and a clad disposed on the outer circumference of the core, and by using a fiber collimator wherein a collimator lens is disposed on the other end face of the coreless fiber on the optical axis of the optical fiber,
these fiber collimators are disposed so as to face with each other, alternately on one side and the other side of one sheet of substrate in accordance with multiplexing and demultiplexing order of light, with a disposal space of optical elements including the wavelength selective filter sandwiched between them, and each fiber collimator is positioned by disposing it in a positioning groove formed within the same face of the substrate, and
further at least one set of the fiber collimator having a relation of facing with each other by being disposed on the one side and the other side of the substrate through the wavelength selective filter is disposed in the positioning groove formed on the same axial line, and a light path correcting board is disposed on the light path between both fiber collimators.

10. The optical module according to claim 9, wherein all of the positioning grooves are formed mutually parallel, and an optical path correcting means is interposed at a place where an optical correction occurs by forming the positioning grooves parallel.

11. The optical module according to claim 9, wherein a wavelength demultiplexing device for demultiplexing a wavelength multiplex light in multi-stages is constituted, by using the fiber collimator on the uppermost stream side in the traveling direction of the light when used as a demultiplexer as a collimator for input light whereby the wavelength multiplex light sent from the external light transmission path for input is made incident to the wavelength selective filter on the uppermost stream side as an input light, using the fiber collimator on the lowermost stream side as a collimator for output whereby the light reflected by the wavelength selective filter on the lowermost stream side is sent out to the external light transmission path for output, and using the other fiber collimator as a collimator for branch light for extracting outside the light transmitted through each wavelength selective filter.

12. The optical module according to claim 9, which is constituted as an optical wavelength multiplexing device by using the fiber collimator on the uppermost stream side in a traveling direction of light when used as a multiplexer as a collimator for input light whereby the light sent from an external light transmission path for input is made incident to the surface of the wavelength selective filter on the uppermost stream side as an input light, using a fiber collimator on the lowermost stream side as a collimator for output light whereby multiplex light of reflected light and insert light is sent to the external light transmission path for output, the reflected light being reflected by the wavelength selective filter on the lowermost stream side and insert light being transmitted through this filter, and using the other fiber collimator as a collimator for insert light whereby insert light of a particular wavelength for each filter is made incident to the backside of each wavelength selective filter.

13. The optical module according to claim 1, wherein
as an optical element having the filter function, a wavelength selective filter for demultiplexing is provided, whereby only the light of a particular wavelength out of the wavelength multiplex light made incident from the first fiber collimator is allowed to transmit toward the second fiber collimator and reflect the light of other wavelength, and a light path correcting board is provided between the wavelength selective filter and the second fiber collimator; and
the wavelength selective filter for multiplexing is disposed in the course of the reflected light made incident from the first fiber collimator and reflected by the wavelength selective filter for demultiplexing, whereby the light reflected by the wavelength selective filter for demultiplexing is further reflected by its own surface and transmitted light made incident to and transmitted through its own backside is multiplexed with the aforementioned reflected light which is reflected by its own surface,
a third fiber collimator having the same constitution as that of the first and second fiber collimators is disposed in the course of the reflected light made incident from the first fiber collimator and reflected by the wavelength selective filter for demultiplexing and further reflected by the surface of the wavelength selective filter for multiplexing, and
a fourth fiber collimator having the same constitution as that of the first and second fiber collimators is disposed, whereby the light of the wavelength band transmittable through the backside of the wavelength selective filter for multiplexing is made incident to the backside of the wavelength selective filter for multiplexing, and
the third and fourth fiber collimators are respectively disposed in third and fourth positioning grooves formed on the same plane as the first and second positioning grooves on the substrate.

14. The optical module according to claim 13, wherein the wavelength selective filter for demultiplexing and the wavelength selective filter for multiplexing are formed into wavelength selective filters having the same characteristic of allowing only the light of the same wavelength to transmit therethrough.

15. The optical module according to claim 13, wherein third and fourth positioning grooves are formed so as to be positioned on the same axial line, and in these third and fourth positioning grooves, the third and fourth fiber collimators are respectively disposed and positioned so as to be faced with each other, with the wavelength selective filter for multiplexing sandwiched between them, and further the light path correcting board is disposed between the fourth fiber collimator and the wavelength selective filter for multiplexing.

16. The optical module according to claim 15, wherein the first and second positioning grooves and the third and fourth positioning grooves are formed in parallel to each other, the first positioning groove and the fourth positioning groove are disposed on one side of the substrate, the second positioning groove and the third positioning groove are disposed on the other side of the substrate, and the disposal space of the wavelength selective filter is provided between the one side and the other side of the substrate.

17. An optical module, wherein two wavelength selective filters are made to be one set, having a demultiplexing function of allowing only the light of a particular wavelength out of incident light to transmit and reflect the light of other wavelength, and a multiplexing function of multiplexing transmitted light of a particular wavelength made incident from the backside and transmitted through this side and the reflected light of other wavelength made incident from a front surface and reflected by this surface, and a plurality of sets of wavelength selective filters are provided on a substrate, with the particular wavelength differentiated for each set, and the wavelength selective filters are disposed so that the reflected light reflected by the wavelength selective filter is made incident sequentially from the upstream side toward the downstream side in a traveling direction of the light, and so that two wavelength selective filters of each set are continuously disposed, and the wavelength selective filter on the upstream side is used as a filter for multiplexing and the wavelength selective filter on the downstream side is used as a filter for multiplexing, and collimators are respectively disposed:
(a) on a light path of incident light made incident to the wavelength selective filter for demultiplexing on the uppermost stream side,
(b) on a light path of transmitted light transmitted through the wavelength selective filter for demultiplexing of each set on the upstream side,
(c) on a light path of the incident light made incident to the backside of the wavelength selective filter for multiplexing of each set on the downstream side,
(d) on a light path of the reflected light reflected by the wavelength selective filter for multiplexing on the lowermost stream side,
then, a fiber collimator is used as each collimator,
(e) wherein one end face of a coreless fiber consisting of material having a homogeneous refractive index roughly identical to that of the core is coupled to the end face of the optical fiber which has a core of a center portion and a clad disposed on the outer circumference of the core, and a collimator lens is disposed on the other end face side of the coreless fiber on the optical axis of the optical fiber,
and out of these fiber collimators, the aforementioned (b) fiber collimator on a light path of transmitted light transmitted through the wavelength selective filter for demultiplexing of each set on the upstream side, the aforementioned (d) fiber collimator on a light path of the reflected light reflected by the wavelength selective filter for multiplexing on the lowermost stream side, the aforementioned (a) fiber collimator on a light path of incident light made incident to the wavelength selective filter for demultiplexing on the uppermost stream side, and the aforementioned (c) on a light path of the incident light made incident to the backside of the wavelength selective filter for multiplexing of each set on the downstream side, are disposed so as to be faced with each other on one side and the other side of one substrate, with disposal space of optical elements including the wavelength selective filter sandwiched between the one side and the other side of the substrate, each fiber collimator is disposed and positioned in a positioning groove formed in the same plane with the substrate, and further at least one set of the fiber collimators having a relation of facing with each other between the one side and the other side of the substrate through the wavelength selective filter are disposed in the positioning groove formed on the same axial line, and an optical path correcting board is disposed on the light path between both fiber collimators.

18. The optical module according to claim 17, wherein the wavelength selective filter for demultiplexing and the wavelength selective filter for multiplexing of each set are formed into a wavelength selective filter having the same characteristics of allowing only the light of the same wavelength to transmit therethrough.

19. The optical module according to claim 17, wherein all of the positioning grooves are formed in parallel to each other, and an optical path correcting means is interposed at a place where a correction of an optical path is generated by forming the poisoning grooves in parallel.

20. The optical module according to claim 6, wherein as the optical path correcting means, at least any one of mirror, mirror having a ginbal mechanism, a totally reflective prism, and a refractive prism is used.

21. The optical module according to claim 1, wherein as the positioning groove, any one of a V-groove, a round groove, a rectangular groove, and an oval groove is provided.

22. The optical module according to claim 1, wherein when intensity of incident light is not uniform over a wavelength, a gain equalizing filter for correcting a light intensity is used so as to flatten the intensity, as the optical element having the filter function.

23. The optical module according to claim 1, wherein a filter for extracting only a part of a quantity of incident light is used as the optical element having a filter function.

24. A paired combination of optical wavelength multiplexing and demultiplexing devices, comprising a first optical module, wherein two sets of first and second fiber collimators are constituted in such a way that one end face of a coreless fiber, which consists of material having a homogeneous refractive index roughly identical to that of the core, is coupled to the end face of an optical fiber having the core of a center portion and a clad disposed on the outer circumference of the core, and a collimator lens is disposed on the other end face side of the coreless fiber on an optical axis of the optical fiber, and the fiber collimators thus constituted are disposed so as to face with each other in a first and second positioning grooves formed on one substrate so as to be positioned on the same axial line, and optical elements having a filter function are arranged between facing surfaces of the fiber collimators,
a wavelength selective filter having a demultiplexing function of allowing only the light of a particular wavelength out of the wavelength multiplex lights made incident to this filter from the first fiber collimator to transmit toward the second fiber collimator and reflect the light of other wavelength, and a multiplexing function of multiplexing toward the first fiber collimator transmitted light of a particular wavelength being made incident to and transmit through one side of this filter from the second fiber collimator, and reflected light of a particular wavelength made incident to and reflect from the other side, and
an optical path correcting board is provided between the wavelength selective filter and the second fiber collimator,
wherein a third fiber collimator having the same constitution as that of the first and second fiber collimators is disposed in the course of the reflected light made incident from the first fiber collimator and is reflected by the wavelength selective filter, and this third fiber collimator is positioned in a third positioning groove formed on the same plane as the first and second positioning grooves on the substrate,
wherein an optical wavelength demultiplexing device demultiplexes a wavelength multiplex light by using the first fiber collimator as a collimator for input light that allows the wavelength multiplex light sent from an external light transmission path for input to be made incident to the wavelength selective filter as input light, using the second fiber collimator as a collimator for branch light for extracting outside the light of a particular wavelength made incident to and transmitted through the wavelength selective filter, and using the third fiber collimator as a collimator for output light for sending light of the wavelength excluding the particular wavelength made incident to and reflected by the wavelength selective filter to an external light transmission path for output,
and a second optical module according to claim 8 constitutes an optical wavelength multiplexing device paired and combined with the optical wavelength demultiplexing device.

25. A paired combination of optical wavelength multiplexing and demultiplexing devices, comprising a first optical module, comprising:
a plurality of wavelength selective filters, having a demultiplexing function of allowing only the light of a particular wavelength out of incident lights and reflecting the light of other wavelength, and a multiplexing function of multiplexing transmitted light of a particular wavelength made incident from one side and transmitted through this side and reflected light of other wavelength made incident from other side and reflected by this side, with the particular wavelengths differentiated,
wherein the plurality of selective filters are disposed so that the reflected light reflected by the filter is sequentially made incident from the upstream side to the downstream side in a traveling direction of the light,
collimators are disposed on a light path of incident light made incident to the wavelength selective filter on the uppermost stream side, on a light path of transmitted light that transmits through each wavelength selective filter, and on a light path of the reflected light reflected by the wavelength selective filter on the lowermost stream side, and
as each collimator, one end face of a coreless fiber, which consists of a material having a homogeneous refractive index roughly identical to that of the core, is coupled to an end face of the optical fiber having a core of a center portion and a clad disposed on the outer circumference of the core, and by using a fiber collimator wherein a collimator lens is disposed on the other end face of the coreless fiber on the optical axis of the optical fiber,
these fiber collimators are disposed so as to face with each other, alternately on one side and the other side of one sheet of substrate in accordance with multiplexing and demultiplexing order of light, with a disposal space of optical elements including the wavelength selective filter sandwiched between them, and each fiber collimator is positioned by disposing it in a positioning groove formed within the same face of the substrate, and further at least one set of the fiber collimator having a relation of facing with each other by being disposed on the one side and the other side of the substrate through the wavelength selective filter is disposed in the positioning groove formed on the same axial line, and a light path correcting board is disposed on the light path between both fiber collimators,
wherein a wavelength demultiplexing device for demultiplexing a wavelength multiplex light in multi-stages is constituted, by using the fiber collimator on the uppermost stream side in the traveling direction of the light when used as a demultiplexer as a collimator for input list whereby the wavelength multiplex light sent from the external light transmission path for input is made incident to the wavelength selective filter on the uppermost stream side as an input light, using the fiber collimator on the lowermost stream side as a collimator for output whereby the light reflected by the wavelength selective filter on the lowermost stream side is sent out to the external light transmission path for output, and using the other fiber collimator as a collimator for branch light for extracting outside the light transmitted through each wavelength selective filter,
and a second optical module according to claim 12 constitutes an optical wavelength multiplexing device paired and combined with the first optical wavelength demultiplexing device.
